(19) United States
(12) Patent Application Publication
(10) Pub. No.: US 2025/0270393 A1
(43) Pub. Date: Aug. 28, 2025

(54) COMPOSITIONS FOR ELASTOMERIC COMPOUNDS COMPRSING FUNCTIONALISED DIENE POLYMERS AND TYRES COMPRISING THE SAME

(71) Applicant: Pirelli Tyre S.p.A., Milano (IT)

(72) Inventors: Luca GIANNINI, Milano (IT); Luciano TADIELLO, Milano (IT); Silvia GUERRA, Milano (IT); Antonio PAPAGNI, Milano (IT); Mauro MONTI, Milano (IT); Vito DE BELLIS, Modugno (IT)

(73) Assignee: Pirelli Tyre S.p.A., Milano (IT)

(21) Appl. No.: 18/573,240

(22) PCT Filed: Jun. 29, 2022
(86) PCT No.: PCT/IB2022/056056

§ 371 Date: Dec. 21, 2023

(30) Foreign Application Priority Data
Jun. 30, 2021 (IT) 102021000017195

(51) Int. Cl. C08L 15/00; B60C 1/00; C08C 19/20; C08C 19/22

(52) U.S. Cl. CPC C08L 15/00; B60C 1/00; C08C 19/20; C08C 19/22

(57) ABSTRACT

The present invention relates to compositions for elastomeric compounds for tyres, comprising modified diene polymers (A1) terminated with at least one tetrazole group (E) comprising at least one 2,5 disubstituted tetrazole which may be activated by heating, tyre components and tyres for vehicle wheels comprising them. Advantageously, the present modified diene polymers (A1) impart to the compounds lower hot hysteresis and reduced Payne effect and, consequently, lower rolling resistance and wear. Furthermore, the present polymers do not exhibit the processability problems shown by conventional functionalised diene polymers, with high affinity for white fillers.

The present invention relates to new functionalised diene polymers, terminated with 2,5-disubstituted tetrazoles, their compositions for elastomeric compounds for tyres, tyre components and tyres for vehicle wheels which comprise them.

### PRIOR ART

In elastomeric compounds for tyres, in order to improve the properties thereof, synthetic diene polymers are commonly used such as styrene-butadiene rubbers (SBR), butyl rubbers (BR) or nitrile-butadiene rubbers (NBR), together with or in place of natural diene polymers.

The elastomeric compounds that make up the tyre tread band must retain their physical-mechanical properties as much as possible without causing premature ageing phenomena, and ensure good resistance to tearing and abrasion, a good balance between wet grip and rolling resistance, resulting in greater safety, durability and better fuel economy.

In the tyre industry the use of polymers with a high styrene content, and in particular in elastomeric compounds for making tyre tread bands, is widely known.

In fact, it is believed that the grip characteristics of the tread band, especially under extreme driving conditions, at high speed and cornering, are positively influenced by the presence of high percentages of styrene in the elastomeric polymers and/or copolymers used for the preparation of the elastomeric compositions. In fact, the use of polymers and/or copolymers with a high styrene content allows having a higher glass transition temperature and increasing the hysteresis values of the tread band of the finished tyre. Furthermore, materials comprising styrene guarantee a better resistance to thermal ageing.

However, in order to reduce fuel consumption and environmental impact, most vehicle manufacturers require manufacturers to develop tyres with rolling resistance and therefore material hysteresis ever lower, while maintaining grip features.

Generally, an attempt has been made to balance the properties of elastomeric materials by modulating the molecular weight and the glass transition temperature (Tg) of diene polymers, in the specific case of SBR rubbers, by varying the ratio between styrene and vinyl monomers.

According to the Applicant's experience, the styrene component of styrene-butadiene copolymers determines an increase in the hysteresis with respect to the butadiene homopolymer and therefore has a favourable effect on the grip and on the driving properties in extreme conditions. The styrenic component in particular determines an increase in the glass transition temperature (Tg) of the copolymer with respect to the homopolymer and such increase in Tg in turn leads to an increase in the energy dissipation of the compounds and therefore to the desired effect on the grip. However, the increase in Tg also entails some drawbacks: in fact, at temperatures close to Tg, the compound may be very rigid at the expense of grip, despite the high hysteresis, but above all the rolling resistance and therefore the on the road tyre's wear are still too high for the increasingly stringent standards required by car manufacturers.

It is known that polymers such as SBR rubbers exhibit the phenomenon of “dangling”, i.e. an excessive mobility of the terminal portions of the chains, a phenomenon that increases the hysteresis of the materials that comprise them.

A possible approach to control the dangling of the chains, the hot hysteresis and the performance of the materials, is to appropriately modify the diene polymers such as SBR through functionalisation of the chain ends.

In fact, in the past, to decrease the mobility of these polymers and improve the performance of the materials that incorporate them, functional groups such as alkoxyls, silyl, epoxides, amines, carboxyls, alkoxysilanes, polysiloxanes, pyrrolidones, alcohols and boronic acids, typically capable of reversibly interacting with the reinforcing fillers present in the compounds, in particular with the white fillers such as silica, were introduced into the polymer chain ends.

Examples of SBRs thus functionalised commonly used in this sector are for example marketed under the name of HPR850 and HPR 950 by JSR and SLR 4602 by Arlanxeo.

However, the diene polymers thus functionalised often do not impart the desired hysteretic properties to the materials, especially when the functionalising groups establish reversible attractive interactions with the fillers. In this case, a stable cross-linking is not obtained even after vulcanisation but a dynamic one, with the formation and breaking of labile interactions which, in the conditions of use, results in an excessive increase in the hysteresis of the material.

Furthermore, the use of these functionalised polymers is limited to rubber compounds which include white fillers such as silica and the like, i.e. fillers having affinity for the functionalising groups of said polymers.

Finally, the diene polymers thus functionalised may exhibit problems of processability of the elastomeric mass as they begin to interact with the fillers early, during the initial stages of incorporation, giving rise to a compound which, although not yet vulcanised (green), becomes very difficult to work as too viscous. This phenomenon is particularly marked in cases in which functional groups capable of forming more stable chemical bonds with the filler are adopted, such as those containing amino-silane or alkoxy-silane groups, which effectively improve the hysteretic properties of the vulcanisate, however strongly penalising the processability.

In particular, white fillers such as silica, having particles of significant size and with more reactive centres, may give rise to early interactions with several polymer chains, giving rise to highly cross-linked superstructures with high viscosity, difficult to process.

In order to try to overcome the difficulties of incorporation of the components caused by the hardening of the compound, at an industrial level mixing is generally intensified, extending time or adding other steps, however with an increase in costs, a decrease in productivity and, in any case, an increase in scraps.

The need therefore remains to reduce the rolling resistance of the tyres and therefore to produce increasingly more eco-compatible tyres and, at the same time, with excellent wet grip, good resistance to ageing, tearing and abrasion but also to have materials easily workable in the mixing steps of the tyre manufacturing process prior to vulcanisation.

### SUMMARY OF THE INVENTION

The Applicant has undertaken studies to improve both the properties of the compounds after vulcanisation and their processability, with the aim in particular of decreasing the hot hysteresis and therefore reducing the rolling resistance of the tyres comprising them.

In particular, the Applicant, in light of the limitations associated with the use of functionalised polymers with groups with affinity to the known fillers, has realised that it could be advantageous to control the phenomenon of the dangling of polymers in elastomeric compounds for tyres, irreversibly blocking the chain terminations by means of their anchoring to the polymers themselves rather than by labile interaction with the white reinforcing fillers.

For this purpose, the Applicant's activity has focused on particular functionalised diene polymers, preferably non-reactive under normal mixing conditions and which may be activated ad hoc only in the subsequent steps, especially during vulcanisation, capable of covalently binding to the polymers of the elastomeric matrix.

These functionalised polymers make it easy to incorporate the usual additives, in particular the fillers, into the polymeric mass, without giving rise to early cross-linking or undesired viscosity increases, to then react at a later time, under predetermined conditions, thus blocking the terminations of the same and limiting the dangling effect, all to the advantage of controlling the hysteresis of the materials.

Specifically, the Applicant has dealt with diene polymers initiated and/or terminated with functional groups comprising 2,5-disubstituted tetrazoles capable, following heating and decomposition at predetermined temperatures, to bind covalently to the vinyl double bonds of the diene polymers, unlike the known functionalised diene polymers which instead interact, often reversibly, with the reinforcing fillers.

The reactions of the present tetrazole functional groups with the diene polymers of the compounds lead to a growth of the polymer chains only when appropriate, i.e. at the end of the processing, without giving rise to early cross-linking with an undesirable increase in viscosity.

The use of the present functionalised polymers, which react only when activated and which bind covalently to the matrix, in addition to simplifying and making the preparation process of the compounds more versatile, has also unexpectedly led, in addition to the improvement of the hysteretic properties of the same, to the reduction of the Payne effect, i.e. of the non-linearity of the dynamic behaviour of the cross-linked compound as the deformation increases.

Advantageously, the functionalised diene polymers of the invention allow the optimisation of the above properties irrespective of the type and quantity of reinforcing filler present in the compound.

As regards the reactivity of tetrazoles, it is known from the literature for example from J. K. Stille, A. T. Chen, Macromolecules, 378, 5, 1972, that 2,5-disubstituted tetrazoles, following heating or irradiation with ultraviolet light, decompose, with nitrogen development, generating highly reactive intermediate species (nitrilimines) able to react with double bonds (A=B), such as vinyl groups, as shown in the following Scheme 1:

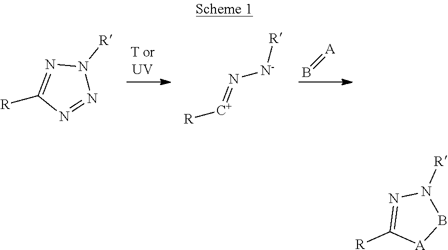

This 1,3-dipolar cyclization reaction leads to the formation of stable substituted pyrazolines, easily recognisable because they are fluorescent when exposed to ultraviolet radiation.

The temperature at which the 2,5-disubstituted tetrazole decomposes, herein also referred to as the activation temperature, depends on the nature of the groups present in the 2,5 positions of the tetrazole, as discussed for example in the article J. Appl. Polym. Science Vol. 28, 3671-3679 (1983) in Table 1, in the article Macromolecules Vol. 5, No. 4, (1972), p. 377-384, in Table 2, and as investigated by the Applicant in the present experimental part (Tables 1 and 2).

To the knowledge of the Applicant, no studies have been conducted on the use of tetrazoles as initiators or terminators of high molecular weight functionalised diene polymers, and in particular of 2,5 disubstituted tetrazoles, in applications with elastomeric materials.

Document JP2009007511A deals with a composition for tyres, comprising a tetrazole derivative mono-substituted in position 5 of formula

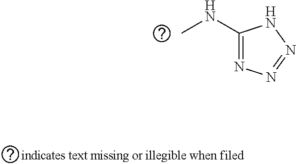

and its vulcanisation, in particular the problems caused by the poor dispersion of silica. This paper does not show or teach the possible thermal activation of tetrazoles at certain temperatures nor does it suggest the use of tetrazoles as functionalisers of polymers. The Applicant has experimentally verified that 5-mono-substituted tetrazoles, such as these, are activated at very high temperatures, higher than 220° C. (as shown by the TGA analysis of FIG. 2).

JP2017039824A discloses a composition, comprising a compound (D) with three or more nitrogen atoms in a ring and a sulphur atom outside the ring, with improved reactivity between a silane coupling agent and rubber. The description does not suggest the use of 2,5-disubstituted tetrazole derivatives as functionalisers of polymers nor does it mention their possible thermal activation at certain temperatures. The Applicant has experimentally verified that 5-mercapto-substituted tetrazoles such as these do not decompose sharply upon heating with the release of nitrogen but degrade slowly, as shown by the thermogram of FIG. 2.

Document JPH03103402A describes an elastomer modified by reaction with 1,5 disubstituted tetrazole of general formula:

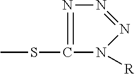

The 1,5-disubstituted tetrazole, if heated, does not decompose sharply with the release of nitrogen but slowly degrades similarly to the tetrazoles described in JP2017039824A. The description does not suggest the use of 2,5-disubstituted tetrazole derivatives as functionalisers of polymers nor does it mention their possible thermal activation at certain temperatures.

The article Macromolecules Vol. 5 pages 377-384 (1972) shows the preparation of high molecular weight synthetic diene copolymers by incorporation in the polymeric skeleton of unsaturated monomers substituted with tetrazoles and diene monomers.

In particular it describes the copolymerization of styrenes substituted with tetrazoles, specifically of monomer 2 (Table 11), with isoprene (page 380, col. on the left, last paragraph) to give the block copolymer 25, or with styrene and butadiene to give the terpolymers of Table Ill. According to the article, these copolymers by heating around 200° C. lead to cross-linked materials with physical properties comparable to those of conventional SBR polymers, usually cross-linked with sulphur and zinc oxide (page 380, col. on the right).

The description does not suggest the use of 2,5-disubstituted tetrazole derivatives as initial or terminal functionalising groups of polymers. The authors do not present any comments or results on the dynamic properties of cross-linked materials.

The article Macromolecules Vol. 46, (2013) pp. 5915-5923, describes oligomers of 1,000 to 38,000 g/mol molecular weight terminated with 2,5-disubstituted tetrazole and their coupling via a maleidiimide compound to prepare nitrile-butadiene (NBR) block copolymers with molecular weight up to 48.000 g/mol.

The 2,5 disubstituted tetrazole functionalising groups are photochemically decomposed to give reactive nitrilimines which selectively react with the activated double bonds of the maleidimide linker rather than with the double bonds of the oligomer. The article does not describe tyre compounds nor does it deal with their dynamic properties after vulcanisation.

The article ACS Omega (2018), 3, 3004-3013 reports a study on the effects of solvents and functionalisations on the physical properties of polyurethanes (PU) obtained by reaction of polybutadienes with hydroxyl terminations (HTPB) and diisocyanates (isophorone diisocyanate IPDI).

Some monosubstituted tetrazoles (M1, M2, and M3) of formula

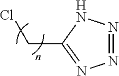

wherein n=1-3, were covalently linked to the terminal carbon of the HTPB to obtain the following three modified HTPBs (P1, P2 and P3 for n 1 to 3)

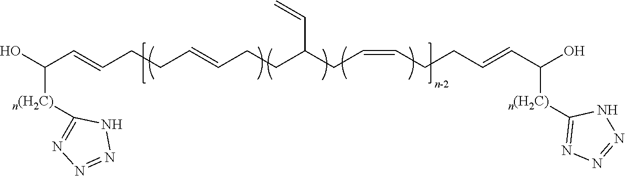

which, subsequently, were converted into the respective PUs by reaction with IPDI. The article does not deal with the field of tyres, the related elastomeric compositions and the possible problems nor does it suggest the thermal decomposition of those tetrazoles or the possible cyclo-addition reactions of the resulting nitrilimines. On the contrary, the authors observe that precisely the tetrazole structure, by virtue of the strong hydrogen bonds, is responsible for the binding of the chains and the good tensile properties of the PU, thus suggesting that the tetrazoles remain intact in the PU.

In its studies, the Applicant has found that it is possible, after vulcanisation of the compound, to limit the excessive terminal mobility of diene polymers and therefore to improve the processability and hysteresis thereof, if at the terminal level said polymers are functionalised with particular tetrazoles which may only be activated when certain temperatures are reached. Upon activation, these tetrazoles decompose, firmly anchoring the polymers to the same polymer chains.

The irreversible additional cross-linking given by these bonds improves the hysteretic properties and unexpectedly the linearity of the dynamic behaviour (Payne effect reduction) of the materials, with undoubted application advantages. On an industrial level, the improved processability of the compound allows the use of conventional mixing plants, increasing productivity and reducing waste.

A first aspect of the present invention therefore is a modified diene polymer (A1) terminated with at least one tetrazole group (E) comprising at least one 2,5 disubstituted tetrazole, wherein said modified diene polymer (A1) has a number average molecular weight Mn higher than 50,000 g/mol measured by gel permeation chromatography (GPC) according to ISO 11344 standard method.

A further aspect of the invention is an elastomeric composition for tyre compounds comprising at least
100 phr of at least one elastomeric polymer (A),
   wherein said 100 phr comprise at least 10 phr of at least one modified diene polymer (A1) according to the invention,
at least 10 phr of at least one reinforcing filler (B), and
from 0 to 20 phr of a vulcanising agent (C).

A further aspect of the present invention is a compound for tyres, green or at least partially vulcanised, obtained by mixing and possibly vulcanising the composition according to the invention.

A further aspect of the present invention is a process for preparing a compound according to the invention, which comprises:
i) mixing, in one or more steps, the components of the composition according to the invention, maintaining the temperature at a value T1 lower than the minimum activation temperature of the at least one 2,5 disubstituted tetrazole of said modified diene polymer (A1), to give a compound (I) comprising said modified diene polymer (A1) having the at least one 2,5 disubstituted tetrazole unreacted, and ii) optionally heating the compound (I) to a temperature T2 at least equal to or higher than the minimum activation temperature of the at least one 2,5 disubstituted tetrazole of said modified diene polymer (A1), to give a compound (II) in which said at least one 2,5 disubstituted tetrazole of said modified diene polymer (A1) has reacted with the double bonds of the elastomeric polymer (A) and/or (A1).

A further aspect of the present invention is a tyre component for vehicle wheels comprising, or preferably consisting of, a green or at least partially vulcanised compound, according to the invention.

A further aspect of the present invention is a tyre for vehicle wheels comprising at least one component of a tyre according to the invention.

Surprisingly, the modified diene polymer (A1) of the invention when incorporated and reacted in elastomeric compounds for tyres, gives them better hysteretic properties and reduces the Payne effect.

Furthermore, the particular reactivity and versatility in the activation temperature of these functionalised diene polymers, depending on the type of substituents linked to the tetrazole ring, allow the applicability and advantages to be modulated ad hoc, a modulation not achievable with conventional functionalised polymers with affinity for reinforcing fillers. In particular, the functionalised diene polymers of the invention exhibit hysteretic properties at least similar, if not better, than traditional highly functionalised polymers without having the processability defects thereof.

### Definitions

The term “electron donating group X” means an atom or a group of atoms, such as —CH₃, —OH, —OR, —NH₂, which contributes to increasing the electron density on nearby atoms.

The term “Y electron withdrawing group” means an atom or a group of atoms, such as —NO₂, —CN, —COOH and halogens, which attract electron charge densities from nearby atoms.

The term “activation temperature”, referred to the modified diene polymer (A1), to the tetrazole group (E) or to the tetrazole functionalising agent (F), means the minimum temperature at which at least one of the 2,5-disubstituted tetrazoles or the 2,5 disubstituted tetrazole decomposes with loss of nitrogen and formation of the reactive intermediate nitrilimine.

The term “composition for tyre compounds” means a composition comprising at least one diene polymer and one or more additives, which by mixing and possible heating provides a compound suitable for use in tyres and their components.

The components of the composition are not generally introduced simultaneously into the mixer but typically added in sequence. In particular, the vulcanisation additives, such as the vulcanising agent (C) and possibly the accelerant and retardant agents, are usually added in a downstream step with respect to the incorporation and processing of all the other components.

In the final vulcanisable compound, the individual components of the composition may be altered or no longer individually traceable as modified, completely or in part, due to the interaction with the other components, to heating and/or mechanical processing. Therefore, the term “composition” herein is meant to include the set of all the components that are used in the preparation of the compound, regardless of whether they are actually present simultaneously, are introduced sequentially or are then traceable in the elastomeric compound or in the final tyre.

The term “compound” indicates the compound obtainable by mixing and optionally heating at least one diene polymer with at least one of the additives commonly used in the preparation of tyre compounds.

The term “cross-linkable compound” indicates the compound ready for cross-linking, obtainable by incorporation into a compound of all the additives, including those of cross-linking.

The term “cross-linked compound” means the material obtainable by cross-linking of a cross-linkable compound.

The term “green” indicates a material, a compound, a composition, a component or a tyre not yet cross-linked.

The term “cross-linking” means the reaction of forming a three-dimensional lattice of inter- and intra-molecular bonds in a natural or synthetic rubber.

The term “vulcanisation” refers to the cross-linking reaction in a natural or synthetic rubber induced by a sulphur-based cross-linking agent.

The term “cross-linking agent” indicates a product capable of transforming natural or synthetic rubber into elastic and resistant material due to the formation of a three-dimensional network of inter- and intra-molecular bonds.

The term “vulcanising agent” means a sulphur-based cross-linking agent such as elemental sulphur, polymeric sulphur, sulphur donating agents such as bis[(trialkoxysilyl)propyl]polysulphides, thiurams, dithiodimorpholines and caprolactam-disulphide.

The term “vulcanisation accelerant” means a compound capable of decreasing the duration of the vulcanisation process and/or the operating temperature, such as TBBS, sulphenamides in general, thiazoles, dithiophosphates, dithiocarbamates, guanidines, as well as sulphur donors such as thiurams.

The term “vulcanisation activating agent” indicates a product capable of further facilitating the vulcanisation, making it happen in shorter times and possibly at lower temperatures. An example of activating agent is the stearic acid-zinc oxide system.

The term “vulcanisation retardant” indicates a product capable of delaying the onset of the vulcanisation reaction and/or suppressing undesired secondary reactions, for example N-(cyclohexylthio)phthalimide (CTP).

The term “vulcanisation package” is meant to indicate the vulcanising agent and one or more vulcanisation additives selected from among vulcanisation activating agents, accelerants and retardants.

The term “functionalising agent (F)” means a compound comprising at least one group (E) comprising at least one 2,5 disubstituted tetrazole capable of reacting and functionalising the diene polymer.

The functionalising agent (F), in the case of anionic polymerisation, may also be referred to as polymerisation initiator or terminator.

The term “diene polymer” indicates a polymer derived from the polymerization of one or more monomers, of which at least one is a conjugated diene.

The term “elastomeric diene polymer” indicates a natural or synthetic diene polymer which, after cross-linking, may be stretched repeatedly at room temperature to at least twice its original length and after removal of the tensile load substantially immediately returns with force to approximately its original length (according to the definitions of the ASTM D1566-11 Standard terminology relating to Rubber).

The term “modified diene polymer” indicates a diene polymer modified by one or more functional groups at the terminations of the polymer chain.

The term “styrene-butadiene rubber (SBR)” refers to a synthetic rubber derived from the copolymerisation of styrene and butadiene monomers.

The term “reinforcing filler” indicates a reinforcing material typically used in the field to improve the mechanical properties of tyre rubbers.

The term “mixing step (1)” indicates a step of the preparation process of the compound in which one or more additives may be incorporated by mixing and optionally heating, except for the vulcanising agent (C) which is fed in step (2). The mixing step (1) is also referred to as “non-productive step”. In the preparation of a compound there may be several “non-productive” mixing steps.

The term “mixing step (2)” indicates a next step of the preparation process of the compound in which the vulcanising agent (C) and, optionally, the other additives of the vulcanisation package are introduced into the compound obtained from step (1), and mixed in the material, at controlled temperature, generally at a compound temperature lower than 120° C., so as to provide the vulcanisable compound. The mixing step (2) is also referred to as “productive step”.

The term “conventional cross-linking process” means a process in which the cross-linking of the compound essentially takes place by vulcanisation with sulphur-based vulcanising agents.

The term “hot hysteresis” in the present context means the hysteresis of the elastomeric material measured at 70° C. or 100° C. as reported in the present experimental part.

For the purposes of the present description and the following claims, the term “phr” (acronym for parts per hundreds of rubber) indicates the parts by weight of a given compound component per 100 parts by weight of the diene polymer, considered net of any plasticising extension oils. Unless otherwise indicated, all the percentages are expressed as percentages by weight.

### BRIEF DESCRIPTION OF THE FIGURES

With reference to the accompanying figures:

FIG. 1 schematically shows a semi-section view of a tyre for vehicle wheels according to the present invention;

FIG. 2 shows the plots of the thermogravimetric analysis (TGA) of the tetrazole compounds shown in the prior art documents JP2009007511 A and JP2017039824A;

FIG. 3 shows the plots of the thermogravimetric analysis (TGA) of the 2,5-disubstituted tetrazole compounds 1.1 and 1.3;

FIG. 4 shows the IR spectrum of liquid polybutadiene (4A) and its reaction product with the tetrazole compound 1.1 (4B);

FIG. 5 shows the H-NMR spectrum of liquid polybutadiene (5A) and its reaction product with the tetrazole compound 1.1 (5B);

FIG. 6 shows the plot of the thermogravimetric analysis (TGA) of a sample comprising liquid polybutadiene and the 2,5 disubstituted tetrazole compound 1.3 in mixture;

FIG. 7 (7A-7C) shows the plots of the thermogravimetric analysis (TGA) of the functionalising agents (F) of formula F2, F4 and F7;

FIG. 8 (8A-8C) shows the H-NMR spectra of the S-SBR1-S-SBR3 polymers terminated with the functionalising agents (F) of formula (F2-F4) (left) and their enlargements (right);

FIG. 9 (9a-9c) shows the GPC chromatograms related to the S-SBR polymers terminated with the tetrazole functionalising agents F2 (S-SBR1), F3 (S-SBR2), F4 (S-SBR3) and the reference (S-SBR4), respectively;

FIG. 10 shows the thermogram of the monoaddition (10A) and diaddition (10B) product between BuLi and functionalising agent F2.

### DETAILED DESCRIPTION OF THE INVENTION

In the present invention, the modified diene polymer (A1), the tyre compound composition, the compound, the process for the preparation thereof, the tyre component and the tyre comprising it are characterised by one or more of the following preferred aspects taken alone or in combination with each other.

A first aspect of the present invention is represented by a modified diene polymer (A1) terminated with at least one tetrazole group (E) comprising at least one 2,5 disubstituted tetrazole and wherein said modified diene polymer (A1) has a number average molecular weight Mn higher than 50,000 g/mol, preferably higher than 100,000 g/mol, more preferably higher than 150,000 g/mol, measured by GPC according to ISO 11344 standard method.

The modified diene polymer (A1) according to the invention preferably has a number average molecular weight Mn comprised between 50,000 and 2,000,000 g/mol, more preferably between 100,000 and 1,000,000 g/mol, measured by GPC according to ISO 11344 standard method. The modified diene polymer (A1) according to the invention more preferably has a number average molecular weight Mn around 200,000 g/mol, measured by GPC according to ISO 11344 standard method.

The modified diene polymer (A1) has a weight average molecular weight Mw preferably higher than 50,000 g/mol, more preferably higher than 100,000 g/mol, even more preferably higher than 200,000 g/mol, measured by GPC according to ISO 11344 standard method. The modified diene polymer (A1) according to the invention preferably has a weight average molecular weight Mw comprised between 50,000 and 3,000,000 g/mol, more preferably between 100,000 and 1,500,000 g/mol, measured by GPC according to the standard ISO 11344 method.

In the modified diene polymer (A1) of the present invention, said tetrazole group (E) is a group comprising a tetrazole covalently linked in position 2 and/or in position 5 to the polymer, of formula (E):

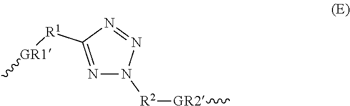

wherein
the symbol [symbol] , represents a possible covalent bond with the diene polymer,
R1 and R2, the same or different from each other and different from H, represent a monovalent or divalent organic residue, providing that at least one of the two is divalent.
GR1′ and/or GR2′, optionally present, represent the residue of a reactive group respectively GR1 and/or GR2 after the reaction with the diene polymer, providing that at least one covalent bond with the diene polymer is present.

In the modified diene polymer (A1) the tetrazole group (E) may be covalently linked to the polymer only in position 2, only in position 5 or in both positions 2 and 5.

The groups R1 and R2 represent a monovalent (ending -yl) or divalent (ending -ylene) organic residue, preferably and independently selected from optionally substituted C₁-C₃₀ alkyl/ylene, C₆-C₂₀ aryl/ylene, heterocyclyl/ylene, —OC₁-C₂₀ alkoxy/alkoxylene, polyoxyethyl/polyoxyethylene, polyterpenes and combinations thereof.

Alkylene, arylene and heterocyclylene refer to an at least divalent radical obtained by removing at least one hydrogen atom from an alkyl, aryl and heterocyclyl, respectively.

R1 and R2 may independently represent a C₁-C₃₀ alkyl/ylene.

The C₁-C₃₀ alkyl/ylene may be a hydrocarbon group, saturated or unsaturated, linear or branched, having at least one or two terminal bond valences, optionally comprising in the chain one or more heteroatoms selected from B, N, S, O, P, Si.

Preferably the alkyl/ylene is a C₁-C₂₀ alkyl/ylene, more preferably C₂-C₁₀, even more preferably C₂-C₈.

The alkyl/yene may be for example —CH₂—, —CH<, —(CH₂)₂₋₂₀—. —CH₂—O—CH₂—, —(O—CH₂—CH₂)—; —(O—CH₂—CH—R)— or the corresponding terminated H alkyl.

R1 and R2 may independently represent a C₆-C₂₀ aryl/ylene.

The C₆-C₂₀ aryl/yene comprises carbocyclic, mono and polycyclic aromatic ring systems, in which the single carbocyclic rings are fused or attached to each other via a single bond.

The C₆-C₂₀ aryl/ylene may be for example phenyl/ylene, biphenyl/ylene, naphthyl/ylene, fluorenyl/ylene, phenanthryl/ylene, para-alkoxy phenyl/ylene, meta-chloro phenyl/ylene.

Preferably, the aryl/ylene is phenyl/ylene.

R1 and R2 may independently represent a heterocyclyl/ylene.

The heterocyclyl/ylene may be mono or bicyclic heterocyclylene, with 5 or 6-member rings, saturated, unsaturated or aromatic, comprising at least one heteroatom selected from N, S and O.

Heterocyclyl/ylene includes heteroaryl/ylene as well as its dihydro and tetrahydro analogues. The binding sites of the heterocyclyl/ylene may be a carbon atom or a heteroatom.

The heterocyclyl/ylene may be derived from a heterocycle such as pyrrole, dihydropyrrole, pyrrolidine, furan, dihydrofuran, tetrahydrofuran, benzofuran, isobenzofuran, dihydrobenzofuran, thiophene, dihydrothiophene, tetrahydrothiophene, benzothiophene, thiazolezole, dihydrothiazole, dihydrothiazole, benzotriazole, tetrazole, dihydrotetrazole, isothiazole, dihydroisothiazole, imidazole, benzoimidazole, dihydroimidazole, dihydrobenzoimidazole, oxazole, dihydrooxazole, benzoxazole, dihydrobenzoxazole, oxazoline, isoxazole, dihydroisooxazole, isoxazoline, oxadiazole, pyrazole, benzopyrazole, dihydropyrazole, pyridine, dihydropyridine, piperidine, piperazine, pyrazine, pyridazine γ-pyran, tetrahydropyran, dihydropyran, 1,4-dioxane, benzo-1,4-dioxane, morpholine, thiomorpholine pyrazine, dihydropyrazine, pyrazoline, quinoline, isoquinoline dihydroquinoline, tetrahydroisoiquinoline, indole, dihydroindolo, isoindole, quinazoline, quinoxaline and the like.

The heterocyclyl/ylene may be an oligomer derived from one or more heterocycles such as for example oligothiophene, oligopyrrole and the like.

Preferably, heterocyclyl/ylene derives from a heterocycle selected from thiophene, dithiophene, oligothiophene, benzothiophene pyrrole, oligopyrrole.

Preferably, R1 and R2 independently represent linear or branched C₃-C₁₀ alkyl/ylene, C₆-C₂₀ aryl/ylene, C₃-C₁₀ cycloalkyl/ylene, monocyclic, saturated, unsaturated or aromatic heterocyclyl/ylene, with 5- or 6-membered rings comprising at least one heteroatom selected from N, S, O, and substituted derivatives thereof. In a particularly preferred embodiment, R1 and/or R2 represent a residue, optionally substituted, derived from phenyl or thiophene.

R1 and R2 may independently comprise one or more electron withdrawing and/or electron donating groups, which may or may not be involved in the formation of the bond with the polymer.

Non-limiting examples of suitable electron withdrawing groups are halogen, acyl —C(O)C₁-C₂₀, carboxyl, ester-COOC₁-C₂₀, amide-CON(C₁-C₂₀)₂, cyano, nitro, haloalkyl, sulphonyl (SO₂), SO₃H and the like.

Non-limiting examples of suitable electron donating groups are hydroxy, C₁-C₁₀ alkoxy, C₁-C₁₀ alkyl, amino, amino mono or disubstituted with C₁-C₁₀ alkyl, primary amide (—NH—COR), hydrazonyl (CH═N—NR₂), urethane, phenyl and the like.

As demonstrated in the experimental part, the choice of residues R1 and R2 and their substituents influences the activation temperature of the tetrazole and provides the expert with a simple means to adapt the reactivity of the system to the specific conditions of the preparation process of the compound and to the desired application.

Non-limiting examples of R1 and R2 are phenyl/ylene, 4-hydroxyphenyl/ylene, 4-carboxyphenyl/ylene, 3,5-dimethylphenyl/ylene, 3,5-dimethoxyphenyl/ylene, 4-octyloxyphenyl/ylene, 4-hexyloxyphenyl/ylene, 4-phenyl-1,2,4-triazolidine-3,5-dione, 1-hexyl/ylene, 2-thiophenyl/ylene, 5-amino-2-thiophenyl/ylene, dithiophenyl/ylene, diphenyl/ylene, ter-thiophenyl/ylene; oligo-2,5-thiophenyl/ylene (with a number of thiophenes from 1-4) also substituted in position 3 and/or 4 with (C₁-C₂₀) alkyl or (C₁-C₂₀) alkoxy chains, naphthalene and anthracene based benzofused polycyclic aromatic systems bearing alkyl and alkoxy chains in the positions not occupied by the tetrazole unit.

To increase the solubility in the elastomeric matrix and in the solvents used in the synthesis processes of functionalised polymers, the organic residues R1 and R2 may comprise more lipophilic groups such as hexyl-phenylenes, 2-ethyl-1-hexyl-phenylenes, naphthalenylenes, fluorenylenes and the like.

The R1 and R2 groups of the tetrazole group (E) independently have a molecular weight preferably lower than 400 g/mol, more preferably lower than 350 g/mol, even more preferably lower than 300 g/mol.

In the modified diene polymer (A1) of the present invention, the tetrazole group (E) may comprise the groups GR1′ and/or GR2′, said GR1′ and/or GR2′ being the residues of the corresponding reactive groups GR1 and GR2 of the functionalising agent (F), as defined below, formed in the reaction with the diene polymer.

GR1′ and/or GR2′ may be independently present, both present or both absent.

GR1′ and/or GR2′ may be absent, for example in the case in which the R1 and/or R2 groups are directly linked to the polymer or in the case in which the respective reactive group GR1 and/or GR2 is completely eliminated in the reaction with the polymer.

GR1′ and GR2′, if present, may be the same or different from each other.

Non-limiting examples of GR1′ and GR2′ groups are the —C(OH)R3- (alcohols), —CO— (ketones), —SO₂— (sulphones), —Si(R4)₂-, —Si(R4)(OR4)-, —Si(OR4)₂-, —Si[N(R4)₂]₂—, —Si—R4N(R4)-, —B(R4)-, —Sn(R4)₂-, —S—, —OP(O)OR4-, —P(O)OR4-, —CO—NR4-, —CS—NR4-, —NR4-CO—, —NR4-CS—, where R3 represents H or R4, and R4 independently represent linear or branched C₁-C₂₀ alkyl or alkenyl, C₆-C₂₀ aryl, C₃-C₁₀ cycloalkyl or cycloalkenyl, monocyclic heterocyclic, saturated, unsaturated or aromatic, with 5- or 6-membered rings comprising at least one heteroatom selected from N, S, O, and substituted derivatives thereof.

GR1′ and/or GR2′ preferably represent —CO—, —C(OH)R3-, —Si(R4)₂-, —Si(R4)(OR4)-, —Si(OR4)₂- or —NHCO—, where R3 and R4 have the above meanings.

The tetrazole group (E) preferably has a molecular weight lower than 800 g/mol, more preferably lower than 600 g/mol, even more preferably lower than 500 g/mol.

Preferably, the modified diene polymer (A1) according to the invention comprises at least a fraction of the total polymer chains which comprise at least one tetrazole group (E) per polymer chain, preferably at least 10%, more preferably at least 30% or 50% of the total polymer chains.

Preferably, the modified diene polymer (A1) according to the invention comprises at least a fraction of the total polymer chains which comprise at least two tetrazole groups (E), the same or different from each other, per polymer chain, preferably at least 10%, more preferably at least 30% or 50% of the total polymer chains.

Preferably, the modified diene polymer (A1) according to the invention comprises at least a fraction of the total polymer chains which comprise more than two tetrazole groups (E), the same or different from each other, per polymer chain, preferably at least 10%, more preferably at least 30% or 50% of the total polymer chains.

Preferably, the modified diene polymer (A1) according to the invention comprises no more than 0.5 mol % of said tetrazole group (E), with respect to the moles of monomers constituting the polymer itself. Preferably, the modified diene polymer (A1) according to the invention comprises from 0.01% to 0.5% mol of said tetrazole group (E), with respect to the moles of monomers constituting the polymer itself.

Preferably, the modified diene polymer (A1) according to the invention comprises at least 0.01% mol of said tetrazole group (E), with respect to the moles of monomers constituting the polymer itself.

In one embodiment, the modified diene polymer (A1) of the invention comprises only one type of tetrazole group (E). In this case, all the tetrazoles present will activate and react with the reactive double bonds of the matrix at the same temperature.

In another embodiment, the modified diene polymer (A1) of the invention comprises two or more different types of tetrazole group (E). In this case, not all the tetrazoles present will activate and react with the reactive double bonds of the matrix at the same temperature but it will be possible to spread the activation and therefore the anchoring of the chains at different temperatures. In fact, the differently substituted tetrazoles will be able to decompose at different T, starting to react at a first temperature called minimum activation temperature and completing the cross-linking when one or more higher T's are reached.

Specific non-limiting examples of the tetrazole group (E) linked to the chain terminations of the diene polymer are the following:

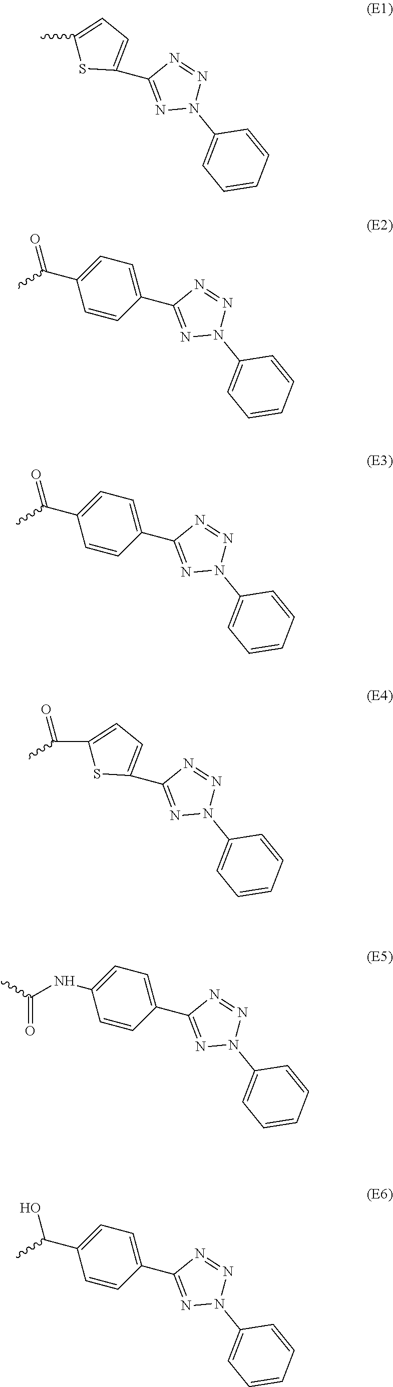

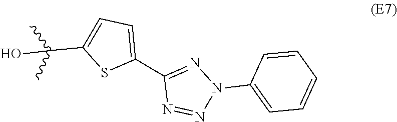

obtainable from the respective functionalising agents (F1-F7), as explained below.

In the present invention, the at least one tetrazole group (E) comprising at least one 2,5 disubstituted tetrazole may be introduced at the terminations of the diene polymer during polymerisation (in-situ functionalisation) or, alternatively, after polymerisation (post-polymerisation functionalisation) by reaction of the living polymer or of a suitably functionalised diene polymer, with at least one functionalising agent (F).

By functionalising agent (F) we mean a reactive agent of formula (F)

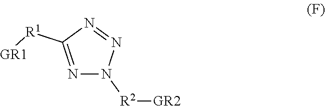

wherein
R1 and R2 independently represent a monovalent or divalent organic residue as previously defined,
GR1 and/or GR2, optionally present, represent a reactive group capable of reacting with the diene polymer.

The reactive group (GR1 and/or GR2) is a group capable of reacting with the reactive functionalities of the terminations at the head and/or at the tail of the polymer, whether it is living polymers bearing carbanions originating from an anionic or Ziegler-Natta type polymerization process (functionalisation in situ) or terminal functional groups of an already functionalised diene polymer (post-functionalisation), forming a covalent bond and thus anchoring the 2,5 disubstituted tetrazole to the diene polymer.

Therefore, the reactive group (GR1 and/or GR2) may be in the case of in situ functionalisation, a carbanion precursor (initiator) or a carbanion acceptor group (terminator). Alternatively, in the absence of the GR1 and GR2 groups, the carbanion precursor may be represented by R1 and/or R2, for example as in the case of the functionalising agents 1.3, 1.17, 1.24 of the present Table 1, in which the carbanion is formed by direct deprotonation of thiophene (R2).

In the case of post-polymerisation functionalisation, the reactive group (GR1 and/or GR2) is a group capable of reacting with the terminal functional groups of the functionalised diene polymer.

The chain initiating functionalising agent (F) comprises at least one 2,5 disubstituted tetrazole and at least one carbanion or carbanion precursor.

The term “carbanion precursor” means an organic group from which a carbanion may be obtained, for example by deprotonation of at least one hydrogen atom that is sufficiently acidic linked to a carbon atom; by lithium-halogen exchange reaction between an organo-lithium compound (lithium linked to sp3 hybridized carbon) and a compound with a C-halogen bond; or by direct reduction of a C-halogen group with an alkaline or alkaline-earth metal.

Non-limiting examples of suitable carbanion precursors are the —CH₂Cl; —CH₂Br; —CH₂₁; —CHCl—; —CHBr—; —CHI—, C(aromatic)-Br; C(aromatic)Cl groups.

In the initiator functionalising agent (F), the carbanion may already be present coupled to a metal cation (pre-formed salt) or preferably it is originated in situ by reaction of the functionalising agent (F) comprising a carbanion precursor with a suitable activator, such as alkyl lithium, for example n-BuLi, iso-BuLi, MeLi, methylaluminoxanes (MAO), TIBA (tri-isobutyl-aluminium) and other classes of similar suitable substances known to those skilled in the art.

Examples of suitable metal cations are the Li⁺ and Al³⁺ cations.

The chain terminating functionalising agent (F) comprises at least one 2,5 disubstituted tetrazole and at least one anion acceptor group (GR1 and/or GR2).

The term “anion acceptor group” refers to an electrophilic group capable of reacting with carbanions by adding to them.

Non-limiting examples of suitable anion acceptor electrophilic GR1 and/or GR2 groups are the —COR3 (aldehydes and ketones), —COOR4 (esters), —CN (nitrile), —CNR4- (imino), —NCO (isocyanate) groups, epoxide, —CO(NR4)₂ (amides), —CSN(R4)₂, —Si(R4)₂Cl, —Si(R4)Cl₂, —SiCl₃, —Si(R4)₂Br, —Si(R4)Br₂, —SiBr₃, —Si(OR4)₃, —SiR4(OR4)₂, —Si(R4)₂(OR4); —Si(R4)₂N(R4)₂, —B(R4)OR4, —B(OR4)₂, —Sn(R4)₂Cl, —S—S—; —OP(O)(OR4)₂, —P(O)(OR4)₂, where R3 represents H or R4, R4 independently represent linear or branched C₁-C₂₀ alkyl or alkenyl, C₆-C₂₀ aryl, C₃-C₁₀ cycloalkyl or cycloalkenyl, saturated, unsaturated or aromatic monocyclic heterocyclene, with 5- or 6-membered rings comprising at least one heteroatom selected from N, S, O, and substituted derivatives thereof.

Non-limiting examples of reactive groups GR1 and/or GR2 suitable to react with the terminal functional groups of the functionalised diene polymer are COR3 (aldehydes and ketones), —COOR4 (esters), CNR4- (imino), —NCO (isocyanate), epoxide, —Si—Cl, —Si—Br, —Si—OR4; —SiN(R4)₂; —B(R4)-OR4′, B—(OR4)₂, —Sn(R4)₂-Cl, wherein R3 and R4 have the above meanings.

Non-limiting examples of terminal functional groups of the functionalised diene polymer suitable to react with the reactive group GR1 and/or GR2 are OH, NH₂, epoxide, anhydride, —NCO (isocyanate).

Non-limiting examples of chain initiator functionalising agent (F) are the compounds of formula

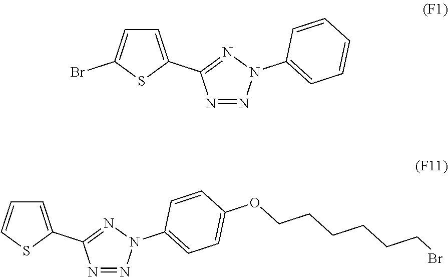 [SMILES: Brc1ccc(-c2nnn(-c3ccccc3)n2)s1 ; BrCCCCCCOc1ccc(-n2nnc(-c3cccs3)n2)cc1]

or compounds 1.3, 1.17, 1.20 and 1.24 of the present Table 1.

Examples of chain terminator functionalising agent (F) are the compounds of formula

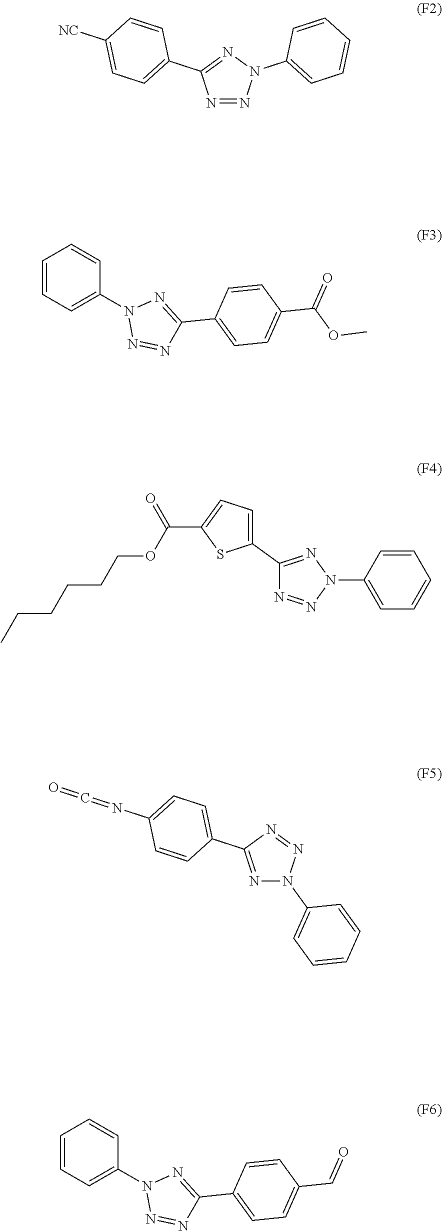

The functionalising agent (F) may be prepared according to one or more conventional synthesis schemes such as those described for example in J. Appl. Polym. Science Vol. 28, 3671-3679 (1983), in Macromolecules Vol. 5, No. 4, (1972), p. 377-384, in Chem. Commun. 2016, 52, 9426, or like those reported in the present experimental part.

In one embodiment, the modified diene polymer is obtained by solution polymerization, emulsion polymerization or gas-phase polymerization of one or more conjugated dienes, optionally mixed with at least one comonomer selected from monoolefins, monovinylarenes and/or polar comonomers in an amount not exceeding 60% by weight.

Preferably, the modified diene polymer (A1) is prepared by anionic polymerisation, more preferably by anionic polymerisation in solution.

In such a case, the at least one tetrazole group (E) may be introduced during the polymerisation by reaction of the living polymer with at least one chain initiator functionalising agent (F) or with at least one chain terminator functionalising agent (F), or with both.

The modified diene polymer (A1) of the invention is preferably prepared by polymerisation, preferably anionic, of at least one conjugated diene, optionally together with one or more monoolefins, preferably monovinyl aromatic compounds and/or optionally together with polar comonomers using an anionic, mono or polyfunctional polymerisation initiator, or optionally an initiator functionalising agent (F) comprising a tetrazole group (F) comprising at least one 2,5-disubstituted tetrazole, and terminating the living polymer by reaction with a conventional polymerisation terminating agent or with a terminating functionalising agent (F) comprising a tetrazole group (E) comprising at least one 2,5-disubstituted tetrazole, providing that at least one between the initiator and the terminator is a functionalising agent (F) as defined herein.

The conjugated diene generally contains from 4 to 12, preferably from 4 to 8 carbon atoms and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene and mixtures thereof. 1,3-butadiene and isoprene are particularly preferred.

Monovinylarenes, which may optionally be used as comonomers, generally contain from 8 to 20, preferably from 8 to 12 carbon atoms and may be selected, for example, from: styrene; 1-vinylnaphthalene; 2-vinylnaphthalene; various alkyl, cycloalkyl, aryl, alkylaryl or arylalkyl derivatives of styrene, such as, for example, α-methylstyrene, 3-methylstyrene, 4-methylstyrene, 4-propylstyrene, 4-cyclohexylstyrene, 4-dodecylstyrene, 2-ethyl-4-benzylstyrene, 4-p-tolyl-styrene, 4-(4-phenylbutyl)styrene, and mixtures thereof. Styrene and 4-methylstyrene are particularly preferred.

The monoolefins may be selected from ethylene and α-olefins generally containing from 3 to 12 carbon atoms, such as for example propylene, 1-butene, 1-pentene, 1-hexene, 1-octene or mixtures thereof.

Polar comonomers that may optionally be used, may be selected, for example, from: vinylpyridine, vinylquinoline, acrylic acid and alkylacrylic acid esters, acrylonitriles, or mixtures thereof, such as, for example, methyl acrylate, ethyl acrylate, methyl methacrylate, ethyl methacrylate, acrylonitrile and mixtures thereof.

Preferably, the modified elastomeric polymer (A1) is selected from the modified diene polymers and copolymers based on alkylene, preferably based on butadiene (BR), isoprene (IR), isoprene/butadiene (IBR) or styrene/butadiene (SBR).

Preferably, the modified diene polymer (A1) is prepared by anionic polymerisation in solution of styrene or derivatives thereof with unsaturated monomers selected from butadiene and/or substituted butadienes such as isoprene, preferably it may be an S-SBR, prepared by anionic polymerisation in solution of butadiene and styrene and/or substituted styrenes such as 4-methylstyrene.

More preferably, the modified diene polymer (A1) is a styrene-butadiene rubber, more preferably styrene-butadiene rubber prepared by anionic polymerisation in solution (S-SBR) and modified in situ.

In a preferred embodiment, the modified diene polymer (A1) comprises from 8% to 70% by weight of styrene monomer and from 30% to 92% of diene monomer, preferably butadiene, which in turn comprises from 5% to 80% of 1,2 vinyl calculated on the butadiene fraction; more preferably, from 10% to 45% of styrene monomer and from 55% to 90% of diene monomer, preferably butadiene, which in turn more preferably comprises from 10% to 70% of 1,2 vinyl calculated on the butadiene fraction.

Preferably, said preferred S-SBR polymer comprises from 8 to 70% of bound styrene and from 5 to 80% of 1,2 vinyl, based on the butadiene component, more preferably from 10 to 45% of bound styrene and from 10 to 70% of 1,2 vinyl, based on the butadiene component.

The modified diene polymer (A1) of the invention is prepared according to processes known to those skilled in the art, preferably by anionic polymerisation, more preferably by anionic polymerisation in solution.

The preferred modified diene polymer (SBR) is typically produced by an anionic solution polymerisation process (S-SBR) initiated for example by conventional initiators such as alkyl-lithiums in organic solvent.

The process is homogeneous with all components dissolved in solution, which provides greater control over the process and the polymer.

The initiator compound, preferably organo-lithium, adds to one of the monomers, generating a carbanion which reacts with another monomer, and so on forming a “living” polymer which is then terminated by reaction with a chain terminating agent.

The anionic polymerization initiator may be an organometallic initiator, in particular a mono or polyfunctional organolithium initiator. A polyfunctional anionic polymerization initiator may be prepared by reacting a polyvinyl aromatic compound with an organolithium compound.

Examples of polyvinyl aromatic compounds used in the preparation of a polyfunctional anionic polymerization initiator include o-, m- and p-divinylbenzene, o-, m- and p-diisopropenylbenzene, 1,2,4-trivinylbenzene, 1,2-vinyl-3,4-dimethylbenzene, 1,3-divinylnaphthalene, 1,3,3,5-trivinyl-naphthalene, 2,4-divinylbiphenyl, 3,5,4′-trivinylbiphenyl, 1,2-divinyl-3,4-dimethylbenzene and 1,5,6-trivinyl-3,7-diethylnaphthalene. In particular, divinylbenzene and diisopropenylbenzene are preferable and the polyvinyl aromatic compound may be a mixture of o, m and p-isomers.

Examples of organolithium compounds are n-butyl lithium, sec-butyl lithium and tert-butyl lithium.

In one embodiment, the initiator may be the carbanion of a functionalising agent (F) as defined above.

Alternatively, the modified diene polymer (A1) according to the invention may be prepared a posteriori, on a finished diene polymer bearing suitable terminal functional groups, for example OH groups, which allow the tetrazole group (E) to be introduced by reaction of said terminal functional groups with the reactive group (GR1 and/or GR2) of the suitable functionalising agent (F).

Commercial examples of functionalised diene polymers suitable for being derivatized by insertion of at least one tetrazole group (E) are the Cray Valley polymers bearing OH terminal groups of the Krasol LBH series, the hydrogenated hydroxy-terminated polybutadienes of the Krasol HLBH-P series, the Poly B polymers with a branched structure, OH terminated.

Preferably, the tetrazole group (E) of the modified diene polymer (A1) of the invention and the respective functionalising agent (F) its precursor, have an activation temperature not lower than 100° C., more preferably not lower than 120° C.

Activation temperatures lower than 100° C. are generally not preferred since they may give rise to cross-linking reactions too early, already during the mixing steps of the components prior to vulcanisation. The early cross-linking would make the compound difficult to process, both in the steps of unloading from the internal mixer and in the extrusion procedures of the semi-finished products, also compromising the integrity of the finished tyre due to the fragility of the material.

Preferably, the tetrazole group (E) and the respective functionalising agent (F) of the modified diene polymer (A1) of the invention, have an activation temperature not higher than 220° C., more preferably not higher than 210° C., even more preferably lower than 200° C.

In a preferred embodiment, the tetrazole group (E) and the respective functionalising agent (F) of the modified diene polymer (A1) of the invention have an activation temperature between 120° C. and 200° C., more preferably between 130° C. and 190° C., even more preferably between 140° C. and 170° C., so as to be activated during the vulcanisation.

Depending on the specific application, the tetrazole group (E) and the respective functionalising agent (F) may have an activation temperature lower, similar to or higher than the vulcanisation temperature of a sulphur-based vulcanising agent possibly present in the compound, typically between 140° C. and 170° C., with possible advantages for both materials and preparation processes.

A lower activation temperature, for example between 110° C. and 140° C., may be advantageous in particular cases of too little viscous compounds as it allows the compound to be partially pre-cross-linked, increasing its viscosity in a controlled manner before conventional vulcanisation. In this case, the mixing steps will be carried out at a controlled T, not higher than the activation T itself.

An activation temperature similar to that of vulcanisation, for example between 130° C. and 170° C., allows the compound to be cross-linked with both cross-linking systems (conventional sulphur-based and according to the invention with the present tetrazole compounds) in a single step, increasing the cross-linking and making it more uniform.

In both the previous cases, the cross-linking advantageously makes the final material less hysteretic and improves the linearity of the dynamic response of the material (reduced Payne effect).

A higher activation temperature, for example from 170° C. up to 220° C. or 230° C., allows proceeding with the conventional preparation steps without having to strictly control the temperature, except to avoid premature sulphur vulcanisation of the compound (mixing T preferably lower than 120° C.).

In particular, such a high activation temperature makes it possible to prepare a compound already vulcanised with sulphur but at the same time still capable of cross-linking when, for example, subjected to particularly stressful conditions of use, with overheating beyond that specific activation temperature. In this way, it is possible to remedy the degradation of the material under stress and control the hysteresis by virtue of the formation of new bonds originating from the reaction of the tetrazole group (E) during the use of the tyre.

Preferably, the modified elastomeric polymer (A1) according to the invention has a glass transition temperature (Tg) lower than 0° C., more preferably between −10° C. and −80° C., even more preferably between −20° C. and −70° C.

The glass transition temperature Tg may be conveniently measured by using a differential scanning calorimeter (DSC) according to ISO 22768 method (“Rubber, Raw—Determination of the glass transition temperatures by differential scanning calorimetry DSC”).

A further aspect of the present invention is a tyre compound composition comprising the modified diene polymer (A1) of the invention.

The tyre compound composition according to the present invention is characterised by one or more of the following preferred aspects taken alone or in combination with each other.

The composition according to the invention comprises 100 phr of at least one elastomeric polymer (A), wherein said 100 phr comprise from 10 to 100 phr, preferably from 30 to 100 phr of at least one modified diene polymer (A1) according to the invention.

In a preferred embodiment, the composition according to the invention comprises 100 phr of at least one elastomeric polymer (A), wherein said 100 phr comprise at least 50 phr, preferably at least 70 phr, more preferably at least 80 phr of at least one modified diene polymer (A1) according to the invention.

In a preferred embodiment, the composition according to the invention comprises 100 phr of modified diene polymer (A1) according to the invention as elastomeric polymer (A) only.

The elastomeric polymer (A) may be selected from those commonly used in sulphur-vulcanisable compositions for tyres, which are particularly suitable for producing tyres, i.e. from among solid polymers or copolymers with an unsaturated chain having a glass transition temperature (Tg) generally lower than 20° C., preferably in the range from 0° C. to −110° C.

These polymers or copolymers may be of natural origin or may be obtained by solution polymerization, emulsion polymerization or gas-phase polymerization of one or more conjugated dienes, optionally mixed with at least one comonomer selected from monoolefins, monovinylarenes and/or polar comonomers in an amount not exceeding 60% by weight.

The conjugated dienes generally contain from 4 to 12, preferably from 4 to 8 carbon atoms and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene and mixtures thereof. 1,3-butadiene and isoprene are particularly preferred.

The monoolefins may be selected from ethylene and α-olefins generally containing from 3 to 12 carbon atoms, such as for example propylene, 1-butene, 1-pentene, 1-hexene. 1-octene or mixtures thereof.

Monovinylarenes, which may optionally be used as comonomers, generally contain from 8 to 20, preferably from 8 to 12 carbon atoms and may be selected, for example, from: styrene; 1-vinylnaphthalene; 2-vinylnaphthalene; various alkyl, cycloalkyl, aryl, alkylaryl or arylalkyl derivatives of styrene, such as, for example, α-methylstyrene, 3-methylstyrene, 4-propylstyrene, 4-cyclohexylstyrene, 4-dodecylstyrene, 2-ethyl-4-benzylstyrene, 4-p-tolyl-styrene, 4-(4-phenylbutyl)styrene, and mixtures thereof. Styrene is particularly preferred.

Polar comonomers that may optionally be used, may be selected, for example, from: vinylpyridine, vinylquinoline, acrylic acid and alkylacrylic acid esters, acrylonitriles, or mixtures thereof, such as, for example, methyl acrylate, ethyl acrylate, methyl methacrylate, ethyl methacrylate, acrylonitrile and mixtures thereof.

Preferably, the elastomeric polymer (A) may be selected, for example, from among: cis-1,4-polyisoprene (natural or synthetic, preferably natural rubber), 3,4-polyisoprene, polybutadiene (in particular polybutadiene with a high content of 1,4-cis), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, and mixtures thereof.

The composition may optionally comprise at least one polymer of one or more monoolefins with an olefinic comonomer or derivatives thereof. The monoolefins may be selected from: ethylene and α-olefins generally containing from 3 to 12 carbon atoms, such as for example propylene, 1-butene, 1-pentene, 1-hexene, 1-octene or mixtures thereof. The following are preferred: copolymers selected from ethylene and an α-olefin, optionally with a diene; isobutene homopolymers or copolymers thereof with low amounts of a diene, which are optionally at least partially halogenated. The possibly present diene generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene or mixtures thereof. Among them, the following are particularly preferred: ethylene/propylene (EPR) copolymers or ethylene/propylene/diene (EPDM) copolymers; polyisobutene; butyl rubber; halobutyl rubbers, in particular chlorobutyl or bromobutyl rubbers; and mixtures thereof.

The composition for tyres according to the present invention comprises at least 10 phr of at least one reinforcing filler (B).

The present composition may comprise from 10 phr to 150 phr, from 10 phr to 120 phr or from 10 phr to 90 phr of at least one reinforcing filler (B).

Preferably, the reinforcing filler (B) is selected from carbon black, white fillers, silicate fibres, optionally pre-treated with acids and/or derivatised, or mixtures thereof.

In an embodiment, said reinforcing filler (B) is a white filler selected from among hydroxides, oxides and hydrated oxides, salts and hydrated salts of metals, silicates fibres or mixtures thereof. Preferably, said white filler is silica.

In one embodiment, the white reinforcing filler (B) is preferably selected from conventional silica and silicates, in the form of fibres, flakes or granules, such as bentonite, nontronite, beidellite, volkonskoite, hectorite, saponite, sauconite, vermiculite, sericite, sepiolite, paligorskite also known as attapulgite, montmorillonite, alloisite and the like, optionally modified by acid treatment and/or derivatized, and mixtures thereof, more preferably it is silica. Examples of silica are a pyrogenic silica, a precipitated amorphous silica, a wet silica (hydrated silicic acid), or mixtures thereof.

Preferably, the white reinforcing filler (B) has a specific surface area (BET) of at least 30 m²/g and less than 400 m²/g.

Advantageously, the white reinforcing filler (B) has a specific surface area (BET) from about 50 m²/g to about 350 m²/g, more preferably from about 70 m²/g to about 240 m²/g.

Examples of suitable commercial silicas are products sold under the brand name Hi-Sil® of PPG Industries Chemicals BV (Pittsburgh, Pa), Ultrasil® of Evonik, or Zeosil® of Rhodia, such as the precipitated silica Rhodia Zeosil MP1165 (BET area specific surface area 160 m²/g), Ultrasil® 7000 (BET specific surface area 160 m²/g) and Zeosil 1115 MP (BET specific surface area 95-120 m²/g).

Preferably, said silica may be present in the composition in an amount ranging between 1 phr and 100 phr, more preferably between 15 phr and 80 phr.

In one embodiment, said reinforcing filler (B) is carbon black.

Preferably, said carbon black is present in the composition in an amount ranging between 1 phr and 100 phr, preferably between 5 phr and 70 phr.

Preferably, the carbon black is selected from those having a surface area not smaller than 20 m²/g, preferably larger than 50 m²/g (as determined by STSA—statistical thickness surface area according to ISO 18852:2005).

The carbon black may be, for example, N234, N326, N330, N375 or N550, N660 marketed by Birla Group (India) or by Cabot Corporation.

The composition for tyre compounds according to the invention may comprise from 0.1 to 10 phr of a vulcanising agent (C).

Preferably, the composition comprises at least 0.2 phr, 0.5 phr, 0.8 phr or 1 phr of at least one vulcanising agent (C).

Preferably, the composition comprises from 0.1 to 10 phr, from 0.2 to 10 phr, from 1 to 10 phr or from 1.5 to 5 phr of at least one vulcanising agent (C).

The at least one vulcanising agent (C) is preferably selected from sulfur, or alternatively, sulfur-containing molecules (sulfur donors), such as for example bis(trialcoxysilyl)propyl]polysulphides and mixtures thereof.

Preferably, the vulcanising agent (C) is sulfur, preferably selected from soluble sulfur (crystalline sulfur), insoluble sulfur (polymeric sulfur), oil-dispersed sulfur and mixtures thereof.

Commercial example of a vulcanising agent (C) suitable for use in the composition of the invention is the Redball Superfine sulphur of International sulphur Inc.

In the present composition, the vulcanising agent (C) may be used together with adjuvants such as vulcanisation activators, accelerants and/or retardants known to those skilled in the art.

The composition according to the invention may optionally comprise at least one vulcanisation activator.

The vulcanisation activating agents suitable for use in the present composition are zinc compounds, in particular ZnO, ZnCO₃, zinc salts of saturated or unsaturated fatty acids containing from 8 to 18 carbon atoms, which are preferably formed in situ in the composition by reaction of ZnO and of the fatty acid, as well as Bi₂O₃, or mixtures thereof. For example, zinc stearate is used, preferably formed in situ in the elastomeric composition, by ZnO and fatty acid, or magnesium stearate, formed by MgO, or mixtures thereof.

The vulcanisation activating agents may be present in the composition of the invention in amounts preferably from 0.2 phr to 15 phr, more preferably from 1 phr to 5 phr.

Preferred activating agents derive from the reaction of zinc oxide and stearic acid. An example of activator is the product Aktiplast ST marketed by Rhein Chemie.

The composition according to the invention may further comprise at least one vulcanisation accelerant.

Vulcanisation accelerants that are commonly used may be for example selected from dithiocarbamates, guanidines, thioureas, thiazoles, sulphenamides, sulphenimides, thiurams, amines, xanthates, or mixtures thereof.

Preferably, the accelerant agent is selected from mercaptobenzothiazole (MBT), N-cyclohexyl-2-benzothiazol-sulphenamide (CBS), N-tert-butyl-2-benzothiazol-sulphenamide (TBBS), tetra-isobutylthiuram disulphide (TiBTD) and mixtures thereof.

Commercial examples of accelerants suitable for use in the present composition are N-cyclohexyl-2-benzothiazyl-sulphenamide Vulkacit® (CBS or CZ), and N-terbutyl 2-benzothiazil sulphenamide, Vulkacit® NZ/EGC marketed by Lanxess.

Vulcanisation accelerants may be used in the present composition in an amount preferably from 0.05 phr to 10 phr, preferably from 0.1 phr to 7 phr, more preferably from 0.5 phr to 5 phr.

The composition according to the invention may optionally comprise at least one vulcanisation retardant agent.

The vulcanisation retardant agent suitable for use in the present composition is preferably selected from urea, phthalic anhydride, N-nitrosodiphenylamine N-cyclohexylthiophthalimide (CTP or PVI) and mixtures thereof.

A commercial example of a suitable retardant agent is N-cyclohexylthiophthalimide VULKALENT G of Lanxess.

The vulcanisation retardant agent may be present in the present composition in an amount of preferably from 0.05 phr to 2 phr.

The present composition may comprise one or more vulcanisation retardant agents as defined above in a mixture.

The composition according to the invention may further comprise at least 0.05 phr, preferably at least 0.1 phr or 0.5 phr, more preferably at least 1 phr or 2 phr of at least one silane coupling agent.

Preferably, the composition according to the invention comprises from 0.1 phr to 20.0 phr or from 0.5 phr to 10.0 phr, even more preferably from 1.0 phr to 5.0 phr of at least one silane coupling agent.

Preferably, said coupling agent is a silane coupling agent selected from those having at least one hydrolysable silane group which may be identified, for example, by the following general formula (III):

(R′)₃Si—CₙH₂ₙ—X (III)

wherein the groups R′, equal or different from each other, are selected from: alkyl, alkoxy or aryloxy groups or from halogen atoms, providing that at least one of the groups R′ is an alkoxy or an aryloxy group; n is an integer of from 1 to 6; X is a group selected from: nitroso, mercapto, amino, epoxide, vinyl, imide, chloro, —(S)ₘCₙH₂ₙ—Si—(R′)₃ and —S—COR′, wherein m and n are integers of from 1 to 6 and the groups R′ are as defined above.

Particularly preferred silane coupling agents are bis(3-triethoxysilylpropyl)tetrasulphide and bis(3-triethoxysilylpropyl)disulphide. Said coupling agents may be added as such or in mixture with an inert filler (such as carbon black) so as to facilitate their incorporation into the elastomeric composition.

An example of the silane coupling agent is TESPT: bis(3-triethoxysilylpropyl) tetrasulphide Si69 marketed by Evonik.

The composition according to the invention may further comprise one or more additional ingredients, commonly used in the field, such as for example plasticising oils, resins, antioxidant and/or antiozonating agents (anti-aging agents), waxes, adhesives and the like.

For example, the composition according to the present invention, in order to further improve the workability of the compound, may further comprise at least one plasticising oil.

The amount of plasticiser is preferably from 1 phr to 80 phr, preferably from 5 phr to 60 phr, more preferably from 10 phr to 30 phr.

The term “plasticising oil” means a process oil derived from petroleum or a mineral oil or a vegetable oil or a synthetic oil or combinations thereof.

The plasticising oil may be a process oil derived from petroleum selected from paraffins (saturated hydrocarbons), naphthenes, aromatic polycyclic and mixtures thereof.

Examples of suitable process oils derived from petroleum are aromatic, paraffinic, naphthenic oils such as MES (Mild Extract Solvated), TDAE (Treated Distillate Aromatic Extract), TRAE (Treated Residual Aromatic Extract), RAE (Residual Aromatic Extract) known in the industry.

The plasticising oil may be an oil of natural or synthetic origin derived from the esterification of glycerol with fatty acids, comprising glycerin triglycerides, diglycerides, monoglycerides or mixtures thereof.

Examples of suitable vegetable oils are sunflower, soybean, linseed, rapeseed, castor and cotton oil.

The plasticising oil may be a synthetic oil selected from among the alkyl or aryl esters of phthalic acid or phosphoric acid.

The composition according to the present invention may further comprise at least one resin.

The resin, if used in the composition, is a non-reactive resin, preferably selected from the group comprising hydrocarbon resins, phenolic resins, natural resins and mixtures thereof.

The amount of resin may be from 0 phr to 80 phr, preferably from 10 phr to 40 phr.

The composition according to the invention may optionally comprise at least one wax.

The wax may be for example a petroleum wax or a mixture of paraffins.

Commercial examples of suitable waxes are the Repsol N-paraffin mixture and the Antilux® 654 microcrystalline wax from Rhein Chemie.

The wax may be present in the composition of the invention in an overall amount generally from 0.1 phr to 20 phr, preferably from 0.5 phr to 10 phr, more preferably from 1 phr to 5 phr.

The composition according to the invention may optionally comprise at least one antioxidant agent.

The antioxidant agent is preferably selected from N-isopropyl-N′-phenyl-p-phenylenediamine (IPPD), N-(-1,3-dimethyl-butyl)-n′-phenyl-p-phenylenediamine (6PPD), N,N′-bis-(1,4-dimethyl-pentyl)-p-phenylenediamine (77PD), N,N′-bis-(1-ethyl-3-methyl-pentyl)-p-phenylenediamine (DOPD), N,N′-bis-(1,4-dimethyl-pentyl)-p-phenylenediamine, N,N′-diphenyl-p-phenylenediamine (DPPD), N,N′-ditolyl-p-phenylenediamine (DTPD), N,N′-di-beta-naphthyl-p-phenylenediamine (DNPD), N,N′-bis(1-methylheptyl)-p-phenylenediamine, N,N′-Di-sec-butyl-p-phenylenediamine (44PD), N-phenyl-N-cyclohexyl-p-phenylenediamine, N-phenyl-N′-1-methylheptyl-p-phenylenediamine and the like, and mixtures thereof, preferably it is N-1,3-dimethylbutyl-N-phenyl-p-phenylenediamine (6-PPD).

A commercial example of a suitable antioxidant agent is 6PPD Santoflex from Eastman.

The antioxidant agent may be present in the composition in an overall amount preferably from 0.1 phr to 20 phr, preferably from 0.5 phr to 10 phr.

A further aspect of the present invention is a compound for tyres, green or at least partially vulcanised, obtained by mixing and possibly vulcanising the composition according to the invention.

The tetrazole functionalities at the head and at the tail of the polymers of the invention are typically decomposed by heating at predetermined temperatures and, by reacting with the present vinyl groups, they create new bonds and cross-links in the polymer mass. The immobilisation of the terminal chains of the polymer, which in the prior art was based on the interaction of the terminal groups with silica, in the present invention takes place by means of covalent bonds formed by reaction of the terminal nitrilimines with the double bonds of the polymer itself or of the polymer matrix.

Surprisingly, the diene polymers (A1) of the invention, when incorporated into the compound, impart advantageous properties to the materials such as a reduced Payne effect, as well as a decrease in the hot hysteresis.

A further aspect of the present invention is a process for preparing the compound according to the invention.

The process for preparing the compound according to the invention preferably comprises:
i) mixing, in one or more steps, the components of the composition according to the invention, maintaining the temperature at a value T1 lower by at least 10° C. than the minimum activation temperature of the at least one 2,5 disubstituted tetrazole of said modified diene polymer (A1), to give a compound (I) comprising said modified diene polymer (A1) having at least one 2,5 disubstituted tetrazole unreacted, and
ii) optionally heating the compound (I) to a temperature T2 at least equal to or higher than the minimum activation temperature of the at least one 2,5 disubstituted tetrazole of said modified diene polymer (A1), to give a compound (II) in which said at least one 2,5 disubstituted tetrazole of said modified diene polymer (A1) has reacted with the double bonds of the elastomeric polymer (A) and/or of the diene polymer (A1).

Depending on the presence or absence of the vulcanising agent (C) and on the activation temperature of the modified diene polymer (A1), different processes may be carried out.

In one embodiment, in which the vulcanising agent (C) is absent, the process preferably comprises step ii) of heating the compound (I) to a temperature T2 at least equal to or greater than the minimum activation temperature of the modified diene polymer (A1), to give a cross-linked compound (11). This step ii) may be carried out in a conventional vulcanisation mould.

In another embodiment, in which the vulcanising agent (C) is instead present and the minimum activation temperature of the modified diene polymer (A1) is lower than or equal to the vulcanisation T, the cross-linking is carried out, before or during vulcanisation, by heating the compound (I) to a temperature T2 at least equal to or greater than the minimum activation temperature of the modified diene polymer (A1) (step ii), to give a cross-linked and vulcanised compound (11).

In another embodiment, in which the vulcanising agent (C) is present and the minimum activation temperature of the modified diene polymer (A1) is higher than the vulcanisation T, the modified diene polymer (A1) is cured but not cross-linked (avoiding step ii), to give a cured compound (II) comprising the unreacted modified diene polymer (A1).

This compound, suitably incorporated in tyre components, for example in the tread band, may undergo cross-linking and, therefore, further consolidation when the temperature of the tyre in use reaches the minimum activation temperature of the modified diene polymer (A1).

The present compound may be prepared according to a process which typically comprises one or more mixing steps in at least one suitable mixer, in particular at least one mixing step 1 (non-productive) and a mixing step 2 (productive) as defined above.

Each mixing step may comprise several intermediate processing steps or sub-steps, characterised by the momentary interruption of the mixing to allow the addition of one or more ingredients, typically without intermediate discharge of the compound. Advantageously, the compound of the present invention, since it does not show significant increases in viscosity before the activation of the tetrazole, may be prepared by mixing in apparatuses and under conventional conditions.

The mixing may be carried out, for example, using an open mixer of the “open-mill” type or an internal mixer of the type with tangential rotors (Banbury®) or with interpenetrating rotors (Intermix), or in continuous mixers of the Ko-Kneader™ type (Buss®) or of the twin-screw or multi-screw type.

The temperatures during the mixing steps and sub-steps may be set according to the minimum activation temperature of the modified diene polymer (A1) and the moment of the process at which the cross-linking is desired.

As previously discussed, the composition may comprise, in addition to the modified diene polymer (A1), also a vulcanising agent (C).

The modified diene polymer (A1) may be incorporated in one or more of the steps 1 or 2, preferably in step 1, while the vulcanising agent (C), if present, only in a non-productive step 2.

The compound may be cross-linked using the modified diene polymer (A1) alone, the vulcanising agent (C) alone, or both. The cross-linking obtained by using the modified diene polymer (A1) may be carried out at a temperature lower than, equal to or higher than the vulcanisation temperature of the compound.

The elastomeric compounds listed above, when they include the vulcanising agent (C), may be vulcanised according to known techniques. To this end, after one or more thermomechanical processing steps, the vulcanising agent (C) is incorporated in the materials, preferably together with vulcanisation accelerants and/or retardants. In the final treatment step (productive step 2), the temperature is generally kept below 120° C. and preferably below 100° C., so as to prevent any undesired pre-vulcanisation phenomena. Thereafter, the vulcanisable compound is incorporated in one or more components of the tyre and subjected to vulcanisation, according to known techniques.

Advantageously, in the compounds according to the invention, unless this is desired, the phenomena of early increase in the viscosity of the elastomeric mass typical of conventional functionalised polymers which already interact with the fillers in the preliminary mixing steps, extremely complicating the preparation process of the compounds themselves and of the components of the tyre that comprise them, do not occur.

A further aspect of the present invention is a tyre component for vehicle wheels comprising, or preferably consisting of, a green or at least partially cross-linked compound, according to the invention, preferably selected from the tread band, under-layer, anti-abrasive layer, sidewall, sidewall insert, mini-sidewall, liner, under-liner, rubber layers, bead filler, bead reinforcing layers (flipper), bead protection layers (chafer), sheet, more preferably the tyre component is selected from tread band, sidewall insert and under-layer.

The tyre component may comprise or preferably may consist, of a compound according to the invention, not cross-linked and not vulcanised (green component), of a compound according to the invention, not cross-linked but vulcanised or not vulcanised but cross-linked (partially cross-linked component) or of a cross-linked and vulcanised compound according to the invention (fully cross-linked component).

A further aspect of the present invention is a tyre for vehicle wheels comprising at least one component according to the invention.

Preferably, the tyre for vehicle wheels of the invention comprises at least one tyre component consisting of a compound according to the invention that is not cross-linked and not vulcanised (green component), of a compound according to the invention that is not cross-linked but vulcanised or not vulcanised but cross-linked (partially cross-linked component) or of a compound according to the invention cross-linked and vulcanised (fully cross-linked component).

Preferably, said component is a tread band or an under-layer.

In one embodiment, a tyre for vehicles according to the present invention comprises at least
a carcass structure comprising at least a carcass ply having opposite lateral edges associated to respective bead structure;
optionally a pair of sidewalls applied to the lateral surfaces of the carcass structure, respectively, in an axially outer position;
optionally a belt structure applied in radially outer position with respect to the carcass structure;
a tread band applied in a radially outer position to said carcass structure or, if present, to the belt structure,
optionally a layer of elastomeric material, referred to as under-layer, applied in a radially inner position with respect to said tread band,
   wherein at least one component, preferably the tread band or the under-layer, comprises, or preferably consists of, the compound according to the invention.

In one embodiment, the tyre according to the invention is a tyre for high performance vehicles (HP, SUV and UHP), wherein at least one component, preferably selected from under-layer and tread band, comprises, or preferably consists of, the compound according to the invention.

In one embodiment, the tyre according to the invention is a tyre for cars, preferably high performance.

In one embodiment, the tyre according to the invention is a tyre for motorcycles, wherein at least one component comprises, or preferably consists of, the compound according to the invention.

The tyre according to the invention may be a tyre for two, three or four-wheeled vehicles.

The tyre according to the invention may be for summer or winter use or for all seasons.

In a preferred embodiment, the tyre according to the invention is a tyre for motorcycle wheels, preferably for sports or racing motorcycles.

In one embodiment, the tyre according to the invention is a tyre for bicycle wheels.

A tyre for bicycle wheels typically comprises a carcass structure turned around a pair of bead cores at the beads and a tread band arranged in a radially outer position with respect to the carcass structure. Preferably, at least the tread band comprises the compound according to the invention.

The tyre according to the present invention may be produced according to a process which comprises:
building components of a green tyre on at least one forming drum;
shaping, moulding and vulcanising the tyre;
wherein building at least one of the components of a green tyre comprises:
manufacturing at least one green component comprising, or preferably consisting of, the vulcanisable compound of the invention.

### DESCRIPTION OF A TYRE ACCORDING TO THE INVENTION

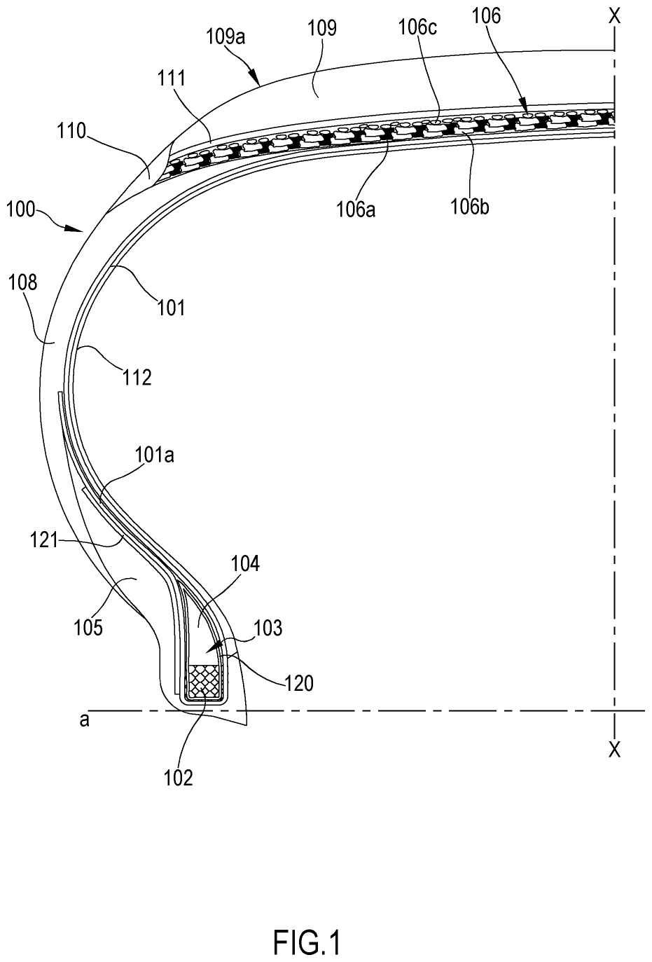

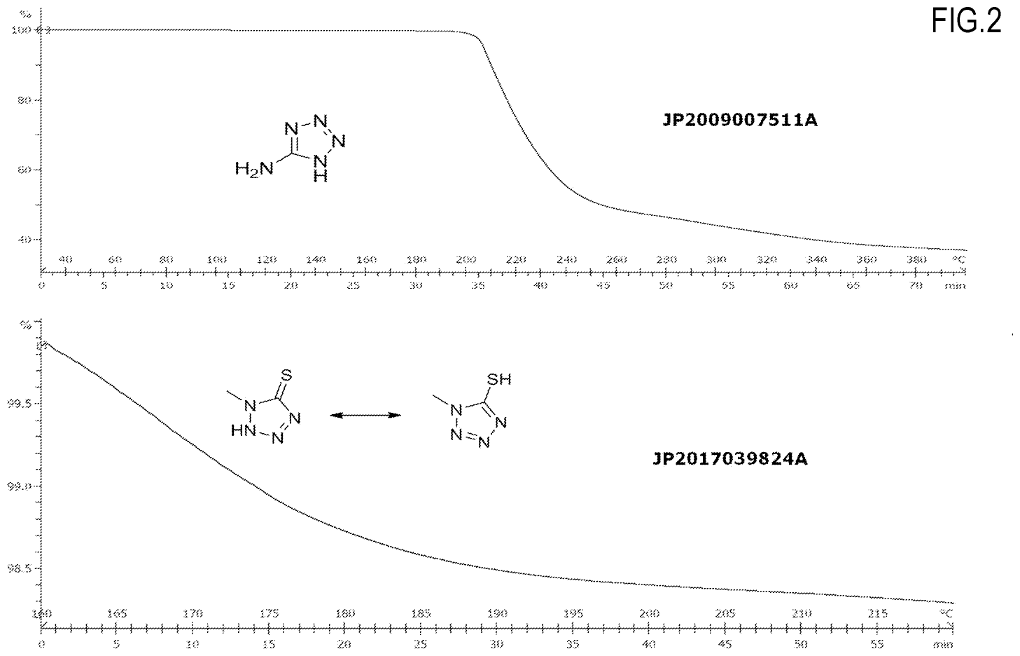

A tyre for vehicle wheels according to the invention, comprising at least one component comprising the present elastomeric compound, is illustrated in radial half-section in FIG. 1.

In FIG. 1, “a” indicates an axial direction and “X” indicates a radial direction, in particular X-X indicates the outline of the equatorial plane. For simplicity, FIG. 1 shows only a portion of the tyre, the remaining portion not shown being identical and arranged symmetrically with respect to the equatorial plane “X-X”.

The tyre (100) for four-wheeled vehicles comprises at least one carcass structure, comprising at least one carcass layer (101) having respectively opposite end flaps engaged with respective annular anchoring structures (102), referred to as bead cores, possibly associated to a bead filler (104).

The tyre area comprising the bead core (102) and the filler (104) forms a bead structure (103) intended for anchoring the tyre onto a corresponding mounting rim, not shown.

The carcass structure is usually of radial type, i.e. the reinforcing elements of the at least one carcass layer (101) lie on planes comprising the rotational axis of the tyre and substantially perpendicular to the equatorial plane of the tyre. Said reinforcing elements generally consist of textile cords, such as rayon, nylon, polyester (for example polyethylene naphthalate, PEN). Each bead structure is associated to the carcass structure by folding back of the opposite lateral edges of the at least one carcass layer (101) around the annular anchoring structure (102) so as to form the so-called carcass flaps (101a) as shown in FIG. 1.

In one embodiment, the coupling between the carcass structure and the bead structure may be provided by a second carcass layer, not shown in FIG. 1, applied in an axially outer position with respect to the first carcass layer.

An anti-abrasive strip (105) possibly made with elastomeric material is arranged in an outer position of each bead structure (103).

The carcass structure is associated to a belt structure (106) comprising one or more belt layers (106a), (106b) placed in radial superposition with respect to one another and with respect to the carcass layer, having typically textile and/or metallic reinforcing cords incorporated within a layer of elastomeric material.

Such reinforcing cords may have crossed orientation with respect to a direction of circumferential development of the tyre (100). By “circumferential” direction it is meant a direction generally facing in the direction of rotation of the tyre.

At least one zero-degree reinforcing layer (106c), commonly known as a “0° belt”, may be applied in a radially outermost position to the belt layers (106a), (106b), which generally incorporates a plurality of elongated reinforcing elements, typically metallic or textile cords, oriented in a substantially circumferential direction, thus forming an angle of a few degrees (such as an angle of between about 0° and 6°) with respect to a direction parallel to the equatorial plane of the tyre, and coated with an elastomeric material.

A tread band (109) comprising the compound according to the invention is applied in a position radially outer to the belt structure (106).

Moreover, respective sidewalls (108) of elastomeric material are applied in an axially outer position on the lateral surfaces of the carcass structure, each extending from one of the lateral edges of tread band (109) at the respective bead structure (103).

In a radially outer position, the tread band (109) has a rolling surface (109a) intended to come in contact with the ground. Circumferential grooves, which are connected by transverse notches (not shown in FIG. 1) so as to define a plurality of blocks of various shapes and sizes distributed over the rolling surface (109a), are generally made on this surface (109a), which for simplicity is represented smooth in FIG. 1.

An under-layer (111) made of elastomeric material may be arranged between the belt structure (106) and the tread band (109), said under-layer preferably extending over a surface substantially corresponding to the extension surface of said belt structure.

A strip consisting of elastomeric material (110), commonly known as “mini-sidewall”, may optionally be provided in the connecting zone between the sidewalls (108) and the tread band (109), this mini-sidewall being generally obtained by co-extrusion with the tread band (109) and allowing an improvement of the mechanical interaction between the tread band (109) and the sidewalls (108). Preferably, the end portion of the sidewall (108) directly covers the lateral edge of the tread band (109).

In the case of tubeless tyres, a rubber layer 112, generally known as “liner”, which provides the necessary impermeability to the inflation air of the tyre, may also be provided in a radially internal position with respect to the carcass layer (101).

The rigidity of the tyre sidewall (108) may be improved by providing the bead structure (103) with a reinforcing layer (120) generally known as flipper or additional strip-like insert.

The flipper (120) is a reinforcing layer which is wound around the respective bead core (102) and the bead filler (104) so as to at least partially surround them, said reinforcing layer being arranged between the at least one carcass layer (101) and the bead structure (103). Usually, the flipper is in contact with said at least one carcass layer (101) and said bead structure (103).

The flipper (120) typically comprises a plurality of textile cords incorporated within a layer of elastomeric material.

The reinforcing annular structure or bead (103) of the tyre may comprise a further protective layer which is generally known by the term of “chafer” (121) or protective strip and which has the function of increasing the rigidity and integrity of the bead structure (103).

The chafer (121) usually comprises a plurality of cords incorporated within a rubber layer of elastomeric material. Such cords are generally made of textile materials (such as aramid or rayon) or metal materials (such as steel cords).

A layer or sheet of elastomeric material may be arranged between the belt structure and the carcass structure. The layer may have a uniform thickness. Alternatively, the layer may have a variable thickness in the axial direction. For example, the layer may have a greater thickness close to its axially outer edges with respect to the central (crown) zone.

Advantageously, the layer or sheet may extend on a surface substantially corresponding to the extension surface of said belt structure.

The compound according to the present invention may advantageously be incorporated in one or more of the above tyre components, preferably in the tread band, in the sidewall insert and/or in the under-layer.

According to an embodiment not shown, the tyre may be a tyre for motorcycle wheels which is typically a tyre that has a straight section featuring a high transverse camber.

According to an embodiment not shown, the tyre may be a tyre for bicycle wheels.

The building of the tyre (100) as described above, may be carried out by assembling respective semi-finished products adapted to form the components of the tyre, on a forming drum, not shown, by at least one assembling device.

At least a part of the components intended to form the carcass structure of the tyre may be built and/or assembled on the forming drum. More particularly, the forming drum is intended to first receive the possible liner, and then the carcass structure.

Thereafter, devices non shown coaxially engage one of the annular anchoring structures around each of the end flaps, position an outer sleeve comprising the belt structure and the tread band in a coaxially centred position around the cylindrical carcass sleeve and shape the carcass sleeve according to a toroidal configuration through a radial expansion of the carcass structure, so as to cause the application thereof against a radially inner surface of the outer sleeve.

After building of green tyre, a moulding and vulcanisation treatment is generally carried out in order to determine the structural stabilisation of the tyre through cross-linking of the elastomeric compositions, as well as to impart a desired pattern on the tread band and to impart any distinguishing graphic signs at sidewalls.

### EXPERIMENTAL PART

### Methods of Analysis

### Thermogravimetric Analysis (TGA)

The thermal behaviour of 2,5-disubstituted tetrazole derivatives and functionalising agents (F) was studied by thermogravimetric analysis, with a Mettler Toledo STARe system.

The tests were carried out in three ways:
1) Determination of the activation temperature: about 10 mg of the tetrazole derivative were inserted into the TGA crucible using a thermal program from 30° C. to 400° C. with a ramp of 5°/min. under N₂flow.

The first weight loss step coincided, as a rule, with the loss of one molecule of nitrogen per tetrazole. The temperature at which the release of nitrogen from the tetrazole began was considered the activation temperature of the tetrazole compound.
2) Determination of the reactivity of the tetrazole derivative with the activated double bonds of a liquid polybutadiene following a typical thermal program of the processing of a compound: about 1 mg of pure tetrazole derivative was dispersed in about 10 mg of Polyvest 130 butadiene oligomer and the mixture placed in the TGA crucible using a thermal program from 30° C. to 140° C. (ramp 10°/min), followed by isotherm at 140° C. for 30 min, cooling to 30° C. (ramp −10°/min), heating from 30° C. to 90° C. (5°/min), cooling to 30° C., heating to 170° C. (5°/min) and isotherm of 30′ at 170° C. 3) Determination of the reactivity of tetrazole with the vinyls of a liquid S-SBR: about 10 mg of tetrazole derivative was dispersed in about 10 mg of S-SBR (Ricon 100) and the mixture placed in the TGA crucible using a thermal program from 30° C. to 400° C. with a ramp of 5°/min under a N₂ flow.

This method has been applied in particular to the tetrazole product formed by the reaction with alkyl lithium of a chain terminating functionalising agent F bearing a halogen (F1) and capable of giving the Li-Halogen exchange reaction. In this way, a derivative model of a polymer functionalised with tetrazole was obtained, allowing the activation temperature of the aforesaid functionalised polymer to be estimated.

### RPA Rheometric Analysis

The dynamic mechanical properties of dynamic shear modulus G′ and Tan delta were evaluated with an Alpha Technologies R.P.A. 2000 oscillating chamber rheometer (Rubber Process Analyser) with chamber geometry as described in ASTM D6601-19 FIG. 1, applying the following method:
1) An approximately cylindrical test sample with a volume in the range from 4.6 to 5 cm³ was obtained by punching a sheet of the green vulcanisable elastomeric compound to be characterised of at least 5 mm of thickness;
2) The chambers of the RPA apparatus were preliminarily preheated to 170° C.:
3) The sample was loaded between the chambers of the RPA apparatus and the chambers were closed. Between the sample of the green vulcanisable elastomeric compound and each chamber of the RPA apparatus, two films were interposed to protect the chamber itself: in contact with the compound, a cast film of Nylon 6.6 of about 25 microns and in contact with the chamber of the RPA apparatus a polyester film of about 23 microns:
4) The sample was then vulcanised for a fixed time of 10 min at a temperature of 170° C. or 190° C. while recording the vulcanisation curve, i.e. subjecting the sample to a sinusoidal deformation of 7% amplitude and 1.67 Hz frequency for the entire duration of the vulcanisation;
5) The temperature of the chambers of the RPA apparatus was then brought to 70° C. in the case of vulcanisation to 170° C., or to 100° C. in the case of vulcanisation to 190° C.; 10 minutes after the chamber temperature was set to the measurement T, a sequence of dynamic measurements was performed at a constant temperature of 70° C. by sinusoidally stressing the sample in torsion at a fixed frequency of 10 Hz and amplitude progressively increasing from 0.3% to 10%, carrying out 10 stabilisation cycles and 10 measurement cycles for each condition.

The result was expressed as dynamic shear modulus G′ and as Tan Delta (ratio between viscous modulus G″ and G′ Tan Delta=G″/G′). The difference between the dynamic shear modulus G′ at deformation of 0.4% and that at deformation of 10% is also reported as an index of the Payne effect.
6) In the case of measurements at 70° C., finally, a dynamic measurement was then performed by sinusoidally stressing the sample in torsion at the fixed frequency of 10 Hz and amplitude of 9%, carrying out 10 stabilisation cycles and 20 measurement cycles: the result was expressed as average of what measured in the 20 measurement cycles, as dynamic shear modulus G′ and as Tan Delta (ratio between viscous modulus G″ and G′, Tan Delta=G″/G′).

Mooney viscosity ML (1+4) at 100° C.: it was measured according to ISO 289-1:2005 standard.

### Measurement of Static Mechanical Properties

The elastomeric materials were vulcanised to give specimens on which the evaluation of the static mechanical properties was carried out.

Unless otherwise indicated, vulcanisation was carried out in a mould, in hydraulic press at 190° C. and at a pressure of 200 bar for about 10 minutes.

The static mechanical properties were measured at 23° C. according to ISO 37:2005 standard.

In particular, the load at different elongation levels (10%, 50%, 100% and 300%, called CA0.1; CA0.5; CA1 and CA3) and the load at break CR on samples of the elastomeric materials mentioned above was measured.

The tensile tests were carried out on straight axis Dumbell specimens.

### 1H-NMR

The NMR spectra were acquired with a Bruker 400 instrument. The samples were prepared by dissolving 5-10 mg of the tetrazole functionalising agent (F) or the modified polymer in 0.6 ml of deuterated solvent (Chloroform or DMSO).

IR The IR spectra were acquired with a Perkin-Elmer spectrum 100 (FT-IR) instrument. The sample was loaded directly onto the crystal and pressed with a metal tip. The spectrum was recorded in ATR (Attenuated Total Reflection) mode

### GPC

Gel permeation chromatography was performed according to ISO 11344 standard. In particular, the samples were prepared by dissolving about 2 mg of polymer in 1 mL of tetrahydrofuran (THF); PSS Polar Sil 2000 Å, 1000 Å, 300 Å columns were used (dimension: 8×300 mm; particle size: 5 μm) and THF as mobile phase; the Astra Software (version 7) was used for data processing.

### Example 1

Study of the Thermal Stability of 2,5-Disubstituted Tetrazoles The following Table 1 shows the 2,5 disubstituted tetrazoles of formula 1.1-1.25 and the respective activation T's:

TABLE 1

| Compound | | Activation |
|---|---|---|
| n. | Formula | T° C. |
| 1.1 | 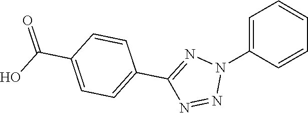 [SMILES: O=C(O)c1ccc(-c2nnn(-c3ccccc3)n2)cc1] | 210 |
| 1.2 | 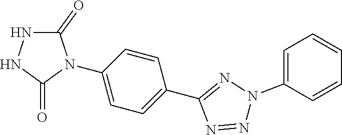 [SMILES: O=c1[nH][nH]c(=O)n1-c1ccc(-c2nnn(-c3ccccc3)n2)cc1] | 200 |
| 1.3 | 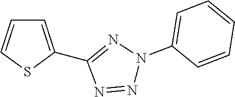 [SMILES: c1ccc(-n2nnc(-c3cccs3)n2)cc1] | 150 |
| 1.4 | 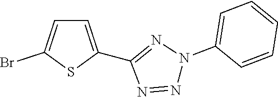 [SMILES: Brc1ccc(-c2nnn(-c3ccccc3)n2)s1] | 150 |
| 1.5 | 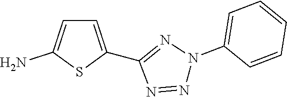 [SMILES: Nc1ccc(-c2nnn(-c3ccccc3)n2)s1] | 165 |
| 1.6 | 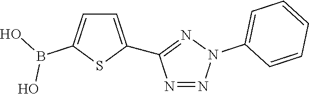 [SMILES: OB(O)c1ccc(-c2nnn(-c3ccccc3)n2)s1] | 140 |
| 1.7 | 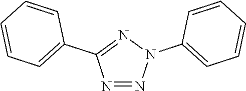 [SMILES: c1ccc(-c2nnn(-c3ccccc3)n2)cc1] | 170 |
| 1.8 | 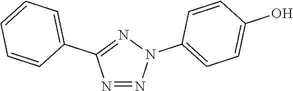 [SMILES: Oc1ccc(-n2nnc(-c3ccccc3)n2)cc1] | 150 |
| 1.9 | 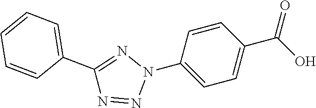 [SMILES: O=C(O)c1ccc(-n2nnc(-c3ccccc3)n2)cc1] | 180 |
| 1.10 | 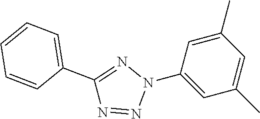 [SMILES: Cc1cc(C)cc(-n2nnc(-c3ccccc3)n2)c1] | 165 |
| 1.11 | 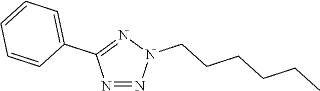 [SMILES: CCCCCCn1nnc(-c2ccccc2)n1] | 150 |
| 1.12 | 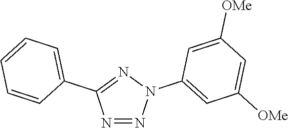 [SMILES: COc1cc(OC)cc(-n2nnc(-c3ccccc3)n2)c1] | 160 |
| 1.13 | 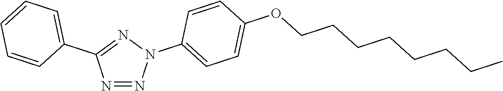 [SMILES: CCCCCCCCOc1ccc(-n2nnc(-c3ccccc3)n2)cc1] | 180 |
| 1.14 | 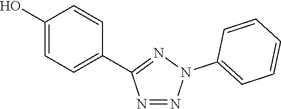 [SMILES: Oc1ccc(-c2nnn(-c3ccccc3)n2)cc1] | 190 |
| 1.15 | 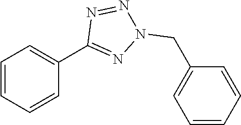 [SMILES: c1ccc(Cn2nnc(-c3ccccc3)n2)cc1] | 200 |
| 1.16 | 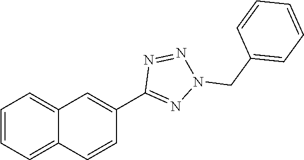 [SMILES: c1ccc(Cn2nnc(-c3ccc4ccccc4c3)n2)cc1] | 220 |
| 1.17 | 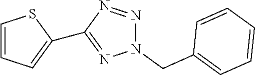 [SMILES: c1ccc(Cn2nnc(-c3cccs3)n2)cc1] | 210 |
| 1.18 | 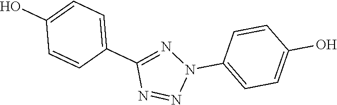 [SMILES: Oc1ccc(-c2nnn(-c3ccc(O)cc3)n2)cc1] | 180 |
| 1.19 | 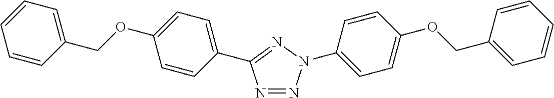 [SMILES: c1ccc(COc2ccc(-c3nnn(-c4ccc(OCc5ccccc5)cc4)n3)cc2)cc1] | 250 |
| 1.20 | 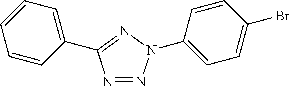 [SMILES: Brc1ccc(-n2nnc(-c3ccccc3)n2)cc1] | 170 |
| 1.21 | 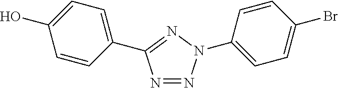 [SMILES: Oc1ccc(-c2nnn(-c3ccc(Br)cc3)n2)cc1] | 200 |
| 1.22 | 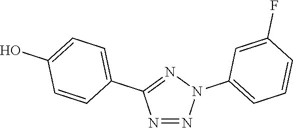 [SMILES: Oc1ccc(-c2nnn(-c3cccc(F)c3)n2)cc1] | 180 |
| 1.23 | 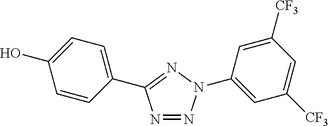 [SMILES: Oc1ccc(-c2nnn(-c3cc(C(F)(F)F)cc(C(F)(F)F)c3)n2)cc1] | 190 |
| 1.24 | 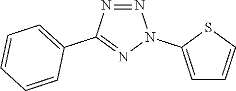 [SMILES: c1ccc(-c2nnn(-c3cccs3)n2)cc1] | 150 |
| 1.25 | 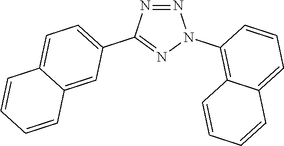 [SMILES: c1ccc2cc(-c3nnn(-c4cccc5ccccc45)n3)ccc2c1] | 100 |

These tetrazole derivatives were analysed by thermogravimetry, in order to investigate the effect of the substituent groups present in position 2 and 5 on the activation temperature of tetrazole.

Among these tetrazole derivatives, the compounds 1.1, 1.2, 1.3 1.4, 1.5, 1.6, 1.8, 1.9, 1.14, 1.18, 1.20, 1.21, 1.22, 1.23, 1.24 may be used as polymerisation initiators or terminators functionalising agents (F) or to bind the 2,5 disubstituted tetrazole core to terminal functional groups of the functionalised diene polymer.

Synthesis of 2,5-Disubstituted Tetrazoles with Aromatic Rings

The tetrazolic compounds having a phenyl in position 2 and an aromatic group optionally substituted in position 5, were prepared as described in Chem. Commun. (2016), 52, 9426, according to the following synthesis Scheme 2 (herein exemplified for derivatives in which the aromatic group in 5 is a phenyl but similarly applicable to derivatives in which said group is another aromatic system):

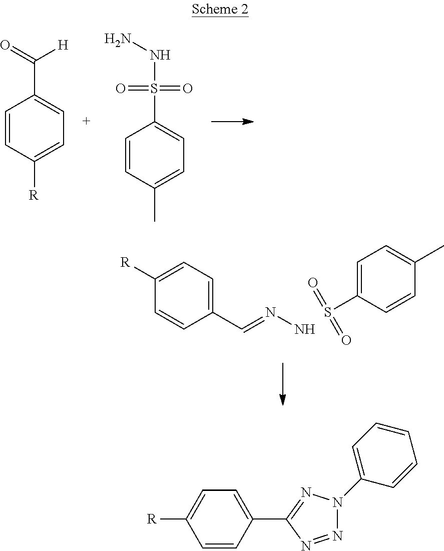

As reported in the literature, the synthesis included two steps:
The aromatic aldehyde (1 eq.) was dissolved in ethanol. Tosylhydrazide (1 eq.) was added and stirred for 4 h at reflux. Water was then added, then the formed precipitate was recovered by filtration. The product thus obtained was used for the second step without further purification.
The solid obtained in step 1 (1 eq.) was dissolved in pyridine to give solution A. In parallel, solution B was prepared by adding a solution of NaNO₂ (1 eq.) in water (xml) to a cooled solution of aniline (1 eq.), conc. HCl and water/ethanol (1:1). Solution B, cooled with an ice bath, was added slowly to solution A by dropping and at the end of the addition it was stirred overnight at room temperature. Subsequently, the reaction mixture was neutralised with diluted HCl, recovering the precipitate formed by filtration. The reaction crude was purified by means of a chromatographic column or crystallized from a suitable solvent according to the type of tetrazole.

### Thermogravimetric Analysis

The 2,5-disubstituted tetrazoles shown in Table 1 were subjected to thermogravimetric analysis according to the method described above.

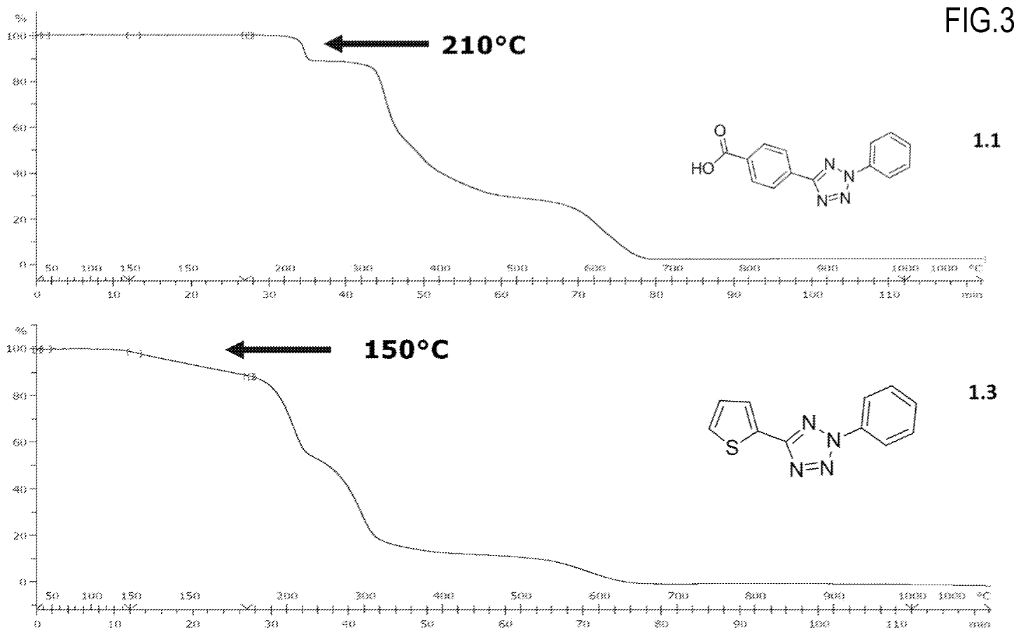

FIG. 3 shows by way of example the plots obtained in the TGA of compounds 1.1 and 1.3. As may be seen, compound 1.1 showed a net jump around 210° C. upon the decomposition of the tetrazole ring with release of nitrogen. Compound 1.3 instead gave rise to a more gradual decomposition starting from about 150° C.

As shown in Table 1, the activation temperature of these derivatives was between 14° and 220° C. and was influenced by the nature of the substituent groups present in position 2 and 5.

In particular, it was observed that electron withdrawing groups, such as for example carboxyl or triazolidinedione (compounds 1.1 and 1.2), if present in the para position of a phenyl bonded to the carbon of the tetrazole ring, stabilised the tetrazole by increasing the activation temperature, while the electron donating groups such as thiophene, optionally substituted with amino or boronic acid (compounds 1.3-1.5) when bound to the carbon of the tetrazole ring had the opposite effect.

From the values of activation temperature reported in Table 1 it appeared that tetrazoles with decomposition T included within a wide range of temperatures of technological interest were synthetically obtainable.

By suitably combining the substituents on the tetrazole it was therefore possible to adapt the activation temperature of the system to the desired application.

### Example 2

Cyclo-Addition Tests with Unsaturated Polymers

To verify the reactivity of the 2,5-disubstituted tetrazole compounds towards the double bonds of polymers, represented in the case of terminal vinyls in the following Scheme 3:

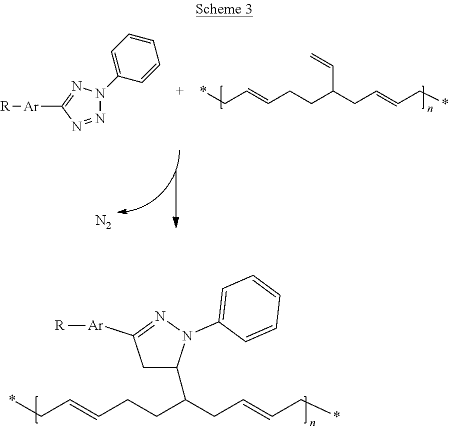

cyclo-addition tests were carried out with some compounds of Table 1, with oligomers, as described in the following Examples 2a, 2b and 2c.

Example 2a: the selected tetrazole derivative and the Polyvest 130S oligomer (tetrazole/polymer ratio 1:100 in moles, tetrazole/polymer vinyl groups ratio 1:1) were mixed in a glass test tube, in the absence of solvent, and the mixture was heated for 15-30 minutes at the tetrazole activation temperature.

For these preliminary cyclo-addition tests useful for evaluating the reactivity of 2,5-disubstituted tetrazoles towards the reactive double bonds of elastomers, Polyvest 1308 (liquid polybutadiene, vinyl content about 1%, molecular weight about 4600 g/mol) was selected because, being liquid, it was easy to mix even without using solvent. Moreover, having the Polyvest a low vinyl content, it allowed evaluating the selectivity of the cyclo-addition reaction towards the terminal vinyl bonds with respect to the internal double bonds.

The formation of pyrazoline after cyclo-addition was highlighted by fluorescence under UV light (365 nm) of the samples and confirmed by the IR and NMR spectra measured at the end of the reaction on the oligomer modified with tetrazole and after having precipitated it in ethanol.

The oligomer was subsequently suspended in ethanol and centrifuged (repeating this process 3 times) to remove the unreacted tetrazole and by-products.

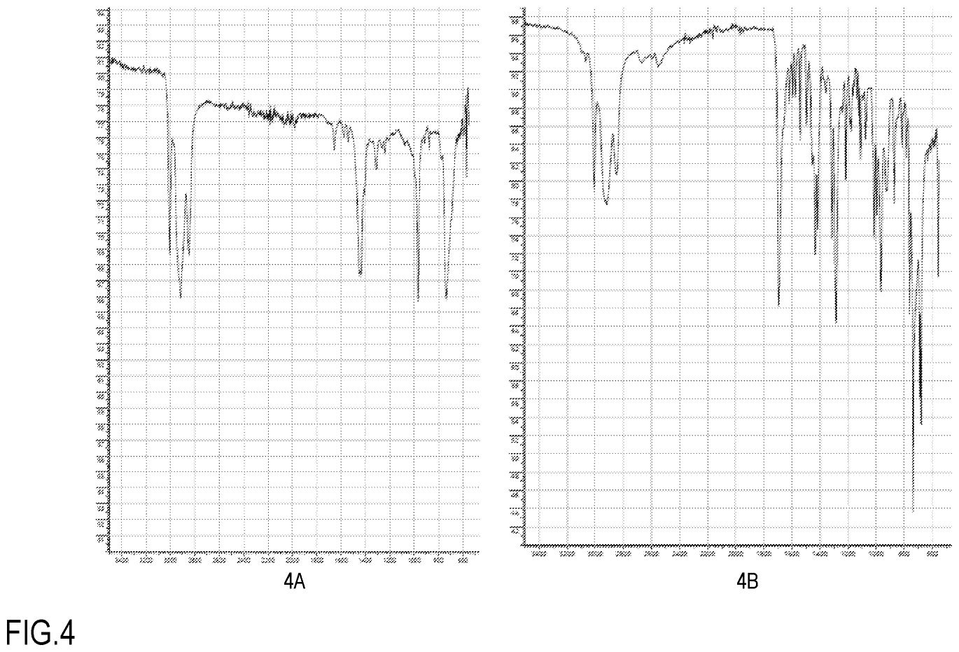

FIG. 4 shows the IR spectra of the Polyvest 130S and of the reaction product between the tetrazole compound 1.1 and the Polyvest 130S measured with the Perkin-Elmer spectrum 100 (FT-IR) apparatus.

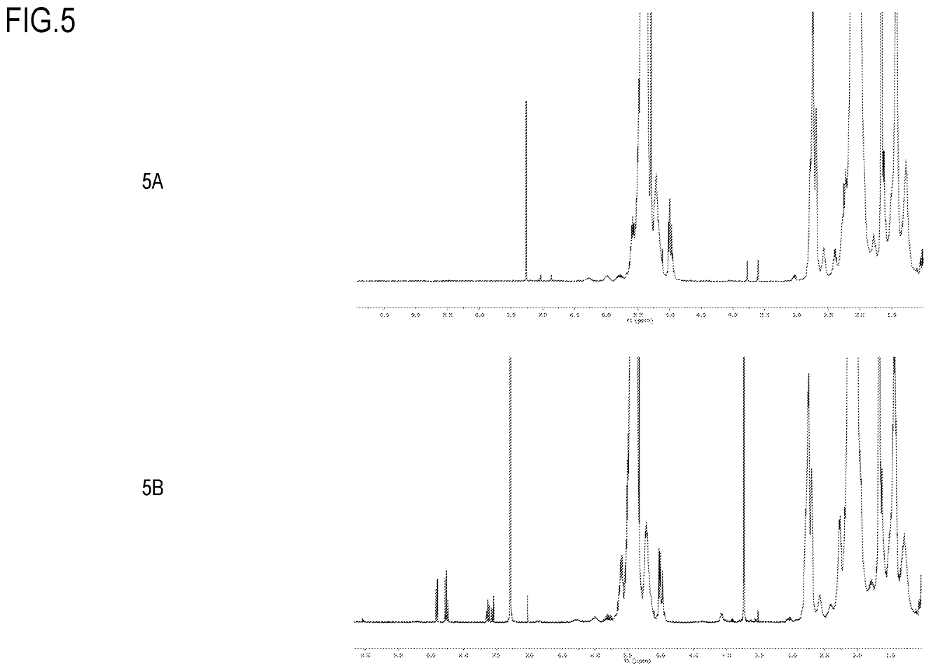

FIG. 5 shows the H-NMR spectrum of the Polyvest before (FIG. 5A) and after (FIG. 5B) the cyclo-addition reaction with the tetrazole compound 1.1.

In the 1H-NMR spectrum after the reaction (FIG. 5B) new signals may be seen compared to those of the Polyvest, attributable to the formation of pyrazoline, in particular the signals around 9.5 ppm (carboxyl proton), those between 8.5 and 8.0 ppm (phenyl protons) and those around 4 ppm (pyrazoline ring protons).

From the tests and analyses conducted in this example, it was shown that the tetrazole had actually reacted with the double bonds, providing the corresponding pyrazoline.

Example 2b: the selected tetrazole derivative and the Polyvest 130S oligomer were mixed in a vial, heating at 70° C. to make the oligomer more fluid and better disperse the tetrazole. A part of the mixture was then placed in the crucible of the thermogravimeter.

The mixture was heated in TGA up to a T higher than the tetrazole activation temperature by at least 20° C. with a heating ramp that led from 70° C. to the final T in 5 minutes, then maintaining this temperature for at least other 5 minutes.

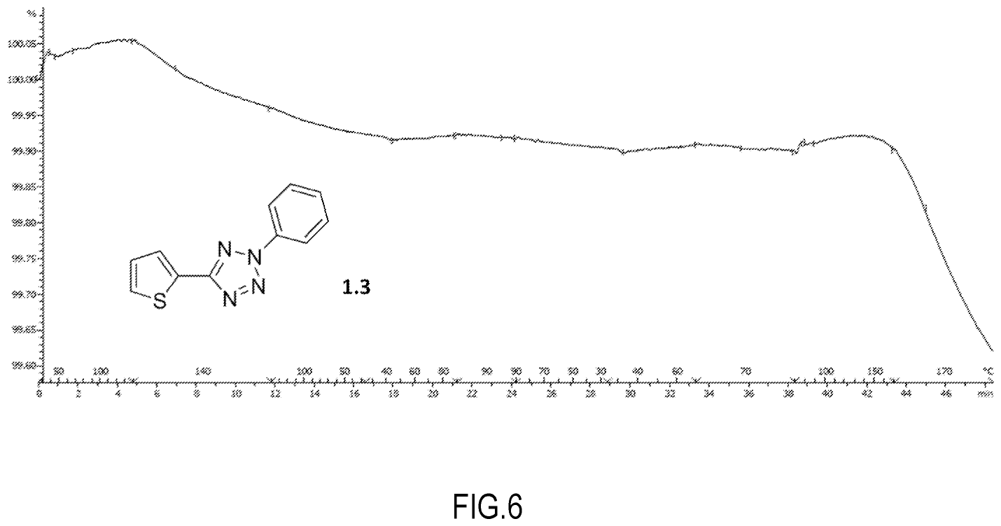

FIG. 6 shows the rapid decrease in the weight of the sample comprising compound 1.3 at temperatures above its activation temperature of 150° C.

Example 2c: Another way of heating the Polyvest 130S—2,5-disubstituted tetrazole 1.3 mixture in TGA was also tested which reproduced the thermal steps to which the elastomeric compound is typically subjected under normal tyre production conditions, comprising in succession: a first heating to 140° C. for 30 minutes, corresponding to an initial mixing step in the absence of cross-linking agent, a cooling to 40° C., a heating at 90° C. for 30 minutes, corresponding to the mixing productive step with incorporation of the cross-linking agent, a second cooling to 30° C. and finally a heating that mimics the cross-linking conditions with T increasing up to at least 20° C. above the activation temperature of the tetrazole. It was shown that tetrazole 1.3 may remain unchanged for the entire thermal cycle of processing of the compound only to activate when the activation T is reached and exceeded, as shown by the only weight loss detectable by TGA.

### Example 3

### Preparation and Evaluation of the Thermal Behaviour of 2,5-Disubstituted Tetrazole Functionalising Agents (F)

The 25-disubstituted tetrazole functionalising agents of formula (F) were prepared

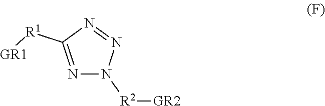

reported in the following Table 2:

TABLE 2

| | | | | | att. |
|---|---|---|---|---|---|
| F | | Formula | GR1-R1 | R2-GR2 | T° C. |
| F1 | I | 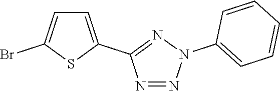 [SMILES: Brc1ccc(-c2nnn(-c3ccccc3)n2)s1] | 2-thienyl-5-Br | C₆H₅— | 150 |
| F2 | T | 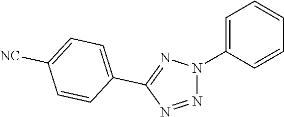 [SMILES: N#Cc1ccc(-c2nnn(-c3ccccc3)n2)cc1] | p-CNC₆H₄— | C₆H₅— | 180 |
| F3 | T | 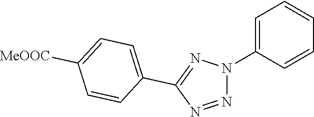 [SMILES: COC(=O)c1ccc(-c2nnn(-c3ccccc3)n2)cc1] | p-CH₃OOCC₆H₄— | C₆H₅— | 190 |
| F4 | T | 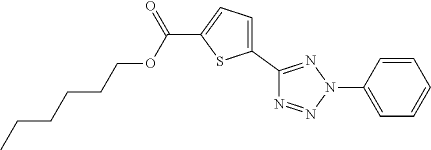 [SMILES: CCCCCCOC(=O)c1ccc(-c2nnn(-c3ccccc3)n2)s1] | 2-thienyl-5- COOC₆H₁₃ | C₆H₅— | 170 |
| F5 | T | 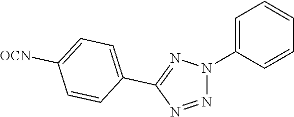 | p-OCN—C₆H₄— | C₆H₅— | NA |
| F6 | T | 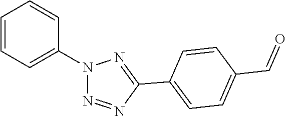 [SMILES: O=Cc1ccc(-c2nnn(-c3ccccc3)n2)cc1] | p-CHO—C₆H₄— | C₆H₅— | NA |
| F7 | T | 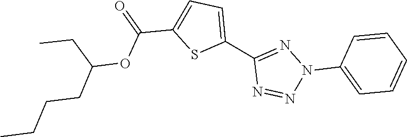 [SMILES: CCCCC(CC)OC(=O)c1ccc(-c2nnn(-c3ccccc3)n2)s1] | 2-thienyl-5- COOC₇H₁₅ | C₆H₅— | 170 |
| F8 | T | 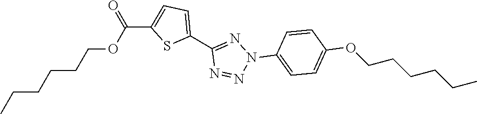 [SMILES: CCCCCCOC(=O)c1ccc(-c2nnn(-c3ccc(OCCCCCC)cc3)n2)s1] | 2-thienyl-5- COOC₆H₁₃ | C₆H₄-p-OC₆H₁₃ | 170 |
| F9 | T | 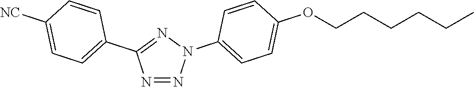 [SMILES: CCCCCCOc1ccc(-n2nnc(-c3ccc(C#N)cc3)n2)cc1] | p-CNC₆H₄ | C₆H₄-p-OC₆H₁₃ | 180 |
| F10 | I | 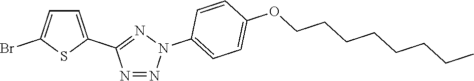 [SMILES: CCCCCCCCOc1ccc(-n2nnc(-c3ccc(Br)s3)n2)cc1] | 2-thienyl-5-Br | C₆H₄-p-OC₈H₁₇— | 150 |
| F11 | I | 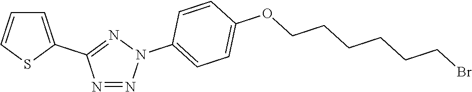 [SMILES: BrCCCCCCOc1ccc(-n2nnc(-c3cccs3)n2)cc1] | 2-thienyl | C₆H₄-p-OC₆H₁₃—Br | 150 |

Key
I: initiator, carbanion precursor;
T: terminator, electrophilic group; and then analysed by thermogravimetry, in order to study the effect of the substituent groups present in position 2 and 5 on the activation temperature of tetrazole.

### Synthesis of 2,5-Disubstituted Tetrazole Functionalising Agents (F)

The tetrazole functionalising agents F1, F2, F3, F6, F9 e F10 having a phenyl in position 2 and an aromatic group optionally substituted in position 5, were prepared as described in Chem. Commun. (2016), 52, 9426.

The other functionalising agents F were prepared in a similar way. but with some additional modification steps. In particular:

Agents F4 and F7 were prepared according to the following Scheme 4:

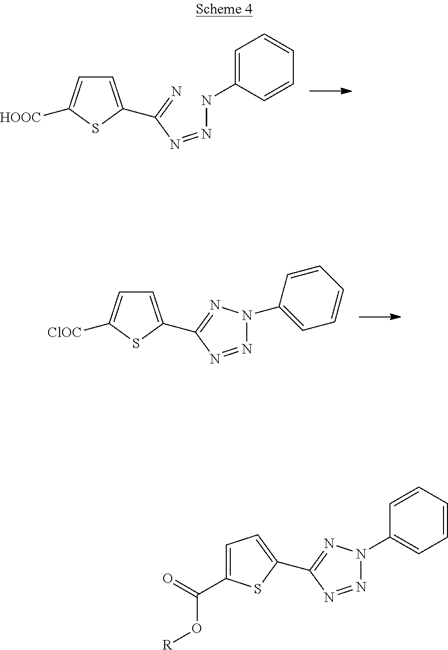

Step 1: 5-(2-phenyl-2H-tetrazol-5-yl)thiophene-2-carboxylic acid (1 eq.) was dissolved in anhydrous THF (tetrahydrofuran), under nitrogen atmosphere. Anhydrous DMF (dimethylformamide) (cat.) and oxalyl chloride (2 eq.) were then added. The reaction was refluxed for 2 h. The progress of the reaction was monitored by IR, checking the shift of the band of the C═O (carbonyl) group. At the end of the reaction, the solvent and the excess oxalyl chloride were removed (yield: 99%). The product was used for the next step without further purification.

Step 2: The product of the previous step (1 eq.) was dissolved in anhydrous DCM (dichloromethane), under a nitrogen atmosphere. DMAP (4-dimethylaminopyridine) (1.1 eq.) and the corresponding alcohol (1-hexanol or 2-ethyl-1-hexanol, 2 eq.) were added, stirring at room temperature overnight. At the end of the reaction, the solvent was evaporated and the crude was purified by chromatography on silica gel (eluent: dichloromethane) to give the clean product (yield: 90%)

F5 was prepared according to the following Scheme 5:

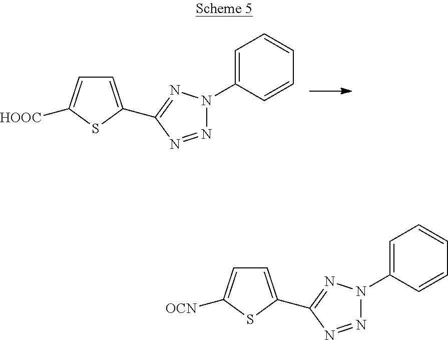

5-(2-phenyl-2H-tetrazol-5-yl)thiophene-2-carboxylic acid (1 eq.) was dissolved in anhydrous THF (tetrahydrofuran), under nitrogen atmosphere, cooling with an ice bath. Subsequently, DPPA (diphenylphosphoryl azide) (1.1 eq.) was added and after 10 min. TEA (triethylamine) (1.1 eq.). The reaction was heated under reflux for 6 h. The progress of the reaction was monitored with IR (formation of the NCO band, isocyanate). At the end of the reaction, the solvent was removed and the product obtained was used without further purification.

F11 was prepared according to the following Scheme 6:

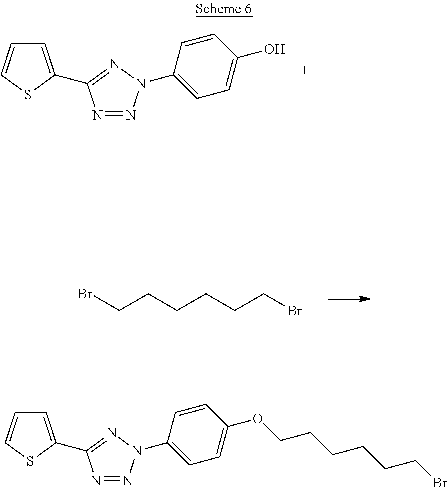 [SMILES: Oc1ccc(-n2nnc(-c3cccs3)n2)cc1 ; BrCCCCCCBr ; BrCCCCCCOc1ccc(-n2nnc(-c3cccs3)n2)cc1]

4-(5-(thiophen-2-yl)-2H-tetrazol-2-yl) phenol (1 eq.) was dissolved in anhydrous DMF (dimethylformamide), under a nitrogen atmosphere. Subsequently, potassium carbonate (1.2 eq.) was added and, after 10 min. 1,6-dibromohexane. It is stirred at room temperature for 48 h. The crude was extracted with ethyl acetate, washing with brine. The organic phase was dried, filtered and evaporated under reduced pressure. The crude was purified by chromatography on silica gel (eluent: dichloromethane) to give the pure product (yield: 98%).

### Thermogravimetric Analysis

The 2,5-disubstituted tetrazole functionalising agents (F) shown in Table 2 were subjected to thermogravimetric analysis according to the previously described method. The measured activation T's are shown in Table 2.

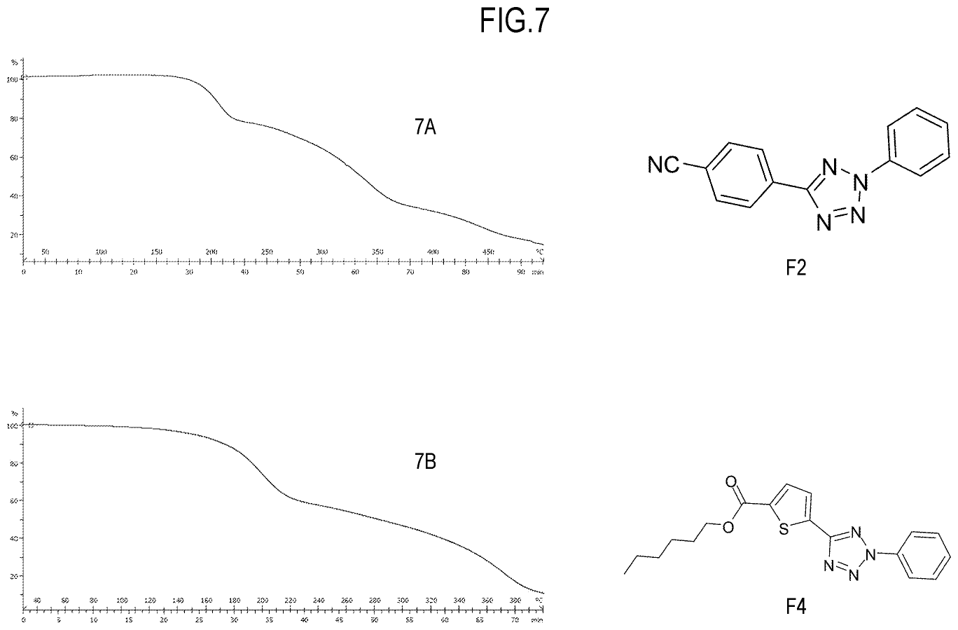

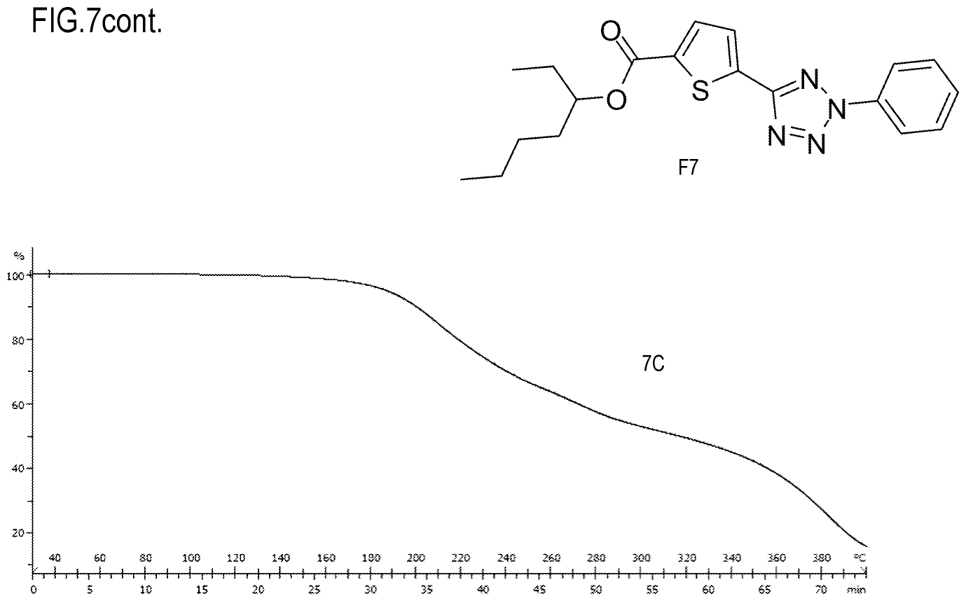

FIG. 7 (7A-7C) shows some exemplary TGA plots related to the decomposition of functionalising agents F2, F4 and F7.

### NMR and IR Analysis

The tetrazole functionalising agents (F1-F11) were characterized by NMR and/or IR spectroscopy.

The assignment of the signals of the analyses carried out is shown here:

### F1

¹HNMR (400 MHz, CDCl₃) δ 8.19-8.14 (m, 2H), 7.66-7.65 (m, 1H), 7.60-7.55 (m, 2H), 7.54-7.49 (m, 1H), 7.15 (d, J=3.9 Hz, 1H)

FTIR-ATR (cm⁻¹): 3144, 3107, 3091, 3066, 3049, 3027, 2535, 2171, 2048, 1978, 1956, 1881, 1771, 1750, 1717, 1692, 1596, 1574, 1496, 1478, 1464, 1408, 1376, 1296, 1215, 1200, 1176, 1108, 1068, 1056, 1003, 981, 948, 910, 885, 799, 760, 743, 704, 690, 674, 667, 615

### F2

¹HNMR (400 MHz, CDCl₃) δ 8.39 (d, J=8.6 Hz, 2H), 8.23-8.18 (m, 2H), 7.83 (d, J=8.6 Hz, 2H), 7.64-7.58 (m, 2H), 7.56 (dd, J=4.9, 3.6 Hz, 1H)

FTIR-ATR (cm⁻¹): 3083, 3065, 3038, 2920, 2395, 2226, 2165, 1803, 1743, 1681, 1594, 1538, 1491, 1472, 1459, 1418, 1370, 1319, 1293, 1277, 1217, 1179, 1145, 1134, 1121, 1106, 1075, 1067, 1013, 1002, 910, 841, 754, 715, 700, 676, 613, 596, 575

### F3

¹HNMR (400 MHz, CDCl₃) δ 8.37-8.33 (m, 2H), 8.24-8.18 (m, 4H), 7.64-7.56 (m, 2H), 7.56-7.50 (m, 1H), 3.97 (s, 3H)

FTIR-ATR (cm⁻¹): 3072, 3028, 2955, 2851, 1773, 1721, 1619, 1596, 1577, 1542, 1496, 1476, 1462, 1452, 1440, 1418, 1374, 1315, 1291, 1278, 1213, 1200, 1161, 1136, 1111, 1077, 1028, 1013, 994, 963, 925, 866, 830, 781, 740, 696, 678, 568

### F4

¹HNMR (400 MHz, CDCl₃) δ 8.18 (d, J=7.9 Hz, 2H), 7.87 (d, J=3.9 Hz, 1H), 7.84 (d, J=3.9 Hz, 1H), 7.59 (t, 2H), 7.53 (t, 1H), 4.34 (t, J=6.7 Hz, 2H), 1.84-1.71 (m, 2H), 1.45 (dd, J=10.0, 5.0 Hz, 3H), 1.36 (td, J=7.2, 3.6 Hz, 4H), 0.92 (t, J=7.0 Hz, 2H)

FTIR-ATR (cm⁻¹): 3322, 3102, 2956, 2929, 2859, 1718, 1595, 1562, 1491, 1469, 1416, 1378, 1329, 1290, 1223, 1197, 1171, 1124, 1073, 1054, 1011, 969, 912, 857, 819, 804, 758, 747, 702, 691, 677, 666, 577

### F5

FTIR-ATR (cm⁻¹): 3065, 2974, 2861, 2338, 2272, 2256, 2170, 2134, 1954, 1792, 1692, 1614, 1594, 1537, 1490, 1471, 1458, 1422, 1374, 1365, 1309, 1288, 1238, 1204, 1180, 1131, 1110, 1092, 1068, 1027, 1011, 986, 968, 912, 898, 861, 757, 730, 694, 678, 633, 617, 595, 561 (the peak around 2133 cm⁻¹ is NCO)

### F6

¹H NMR (400 MHz, CDCl₃) δ 10.04 (s, 1H), 8.38 (d, J=9.0 Hz, 2H), 8.17 (dd, J=11.5, 4.3 Hz, 2H), 7.99 (d, J=8.4 Hz, 2H), 7.54 (t, J=7.6 Hz, 2H), 7.51-7.41 (m, 1H).

### F7

¹H NMR (400 MHz, CDCl₃) δ 8.22-8.15 (m, 2H), 7.87 (d, J=3.9 Hz, 1H), 7.84 (d, J=3.9 Hz, 1H), 7.59 (tt, J=8.8, 1.9 Hz, 2H), 7.53 (ddd, J=7.4, 3.7, 1.3 Hz, 1H), 4.26 (dd, J=5.7, 4.6 Hz, 2H), 3.55 (d, J=5.0 Hz, 1H), 1.72 (dd, J=12.2, 6.1 Hz, 2H), 1.51-1.24 (m, 6H), 0.94-0.84 (m, 6H).

### F8

¹H NMR (400 MHz, CDCl₃) δ 8.10-8.03 (m, 2H), 7.88-7.81 (m, 2H), 7.08-7.01 (m, 2H), 4.33 (t, J=6.7 Hz, 2H), 4.04 (t, J=6.6 Hz, 2H), 1.89-1.71 (m, 4H), 1.53-1.41 (m, 4H), 1.41-1.30 (m, 8H), 0.97-0.86 (m, 6H).

### F9

¹H NMR (400 MHz, CDCl₃) δ 8.41-8.34 (m, 2H), 8.12-8.06 (m, 2H), 7.84-7.79 (m, 2H), 7.10-7.03 (m, 2H), 4.05 (t, J=6.6 Hz, 2H), 1.83 (dt, J=14.5, 6.6 Hz, 2H), 1.49 (dd, J=10.3, 4.8 Hz, 2H), 1.37 (td, J=7.2, 3.7 Hz, 4H), 0.97-0.86 (m, 3H).

### F10

¹HNMR (400 MHz, CDCl₃) δ 8.04 (d, J=9.2 Hz, 2H), 7.63 (d, J=3.9 Hz, 1H), 7.14 (d, J=3.9 Hz, 1H), 7.04 (d, J=9.2 Hz, 2H), 4.03 (t, J=6.6 Hz, 2H), 1.82 (dt, J=14.5, 6.6 Hz, 2H), 1.47 (dd, J=15.4, 7.3 Hz, 2H), 1.41-1.26 (m, 8H), 0.95-0.85 (m, 3H)

FTIR-ATR (cm⁻¹): 3080, 2939, 2919, 2852, 1980, 1896, 1749, 1609, 1598, 1573, 1516, 1484, 1467, 1442, 1410, 1396, 1368, 1305, 1284, 1264, 1215, 1201, 1177, 1145, 1129, 1112, 1072, 1043, 1027, 1004, 981, 953, 893, 876, 828, 796, 756, 744, 720, 688, 671, 660, 631, 574, 560

### F11

¹HNMR (400 MHz, CDCl₃) δ 8.07 (d, J=9.1 Hz, 2H), 7.89 (d, J=3.7, 1.2 Hz, 1H), 7.49 (d, J=5.0, 1.2 Hz, 1H), 7.18 (t, J=5.0, 3.7 Hz, 1H), 7.04 (d, J=9.2 Hz, 2H), 4.04 (t, J=6.4 Hz, 2H), 3.44 (t, J=6.7 Hz, 2H), 1.96-1.89 (m, 2H), 1.85 (dt, J=16.2, 6.9 Hz, 2H), 1.59-1.50 (m, 4H)

The spectra showed the high purity of the isolated species and the presence in all the synthesised compounds of signals in the region from 7.5 to 8.5 ppm, particularly relevant as far from the region in which the characteristic signals of a typical S-SBR polymer were recorded. The signals in the 7.5-8.5 ppm region were therefore diagnostic of the presence of tetrazoles or species derived from them in the investigated systems, as already discussed above with reference to FIG. 5 for the case of functionalised polybutadienes.

### Example 4: Reactivity Tests of Functionalising Agents (F) as Initiators or Terminators of Polymers (In Situ Functionalisation)

To verify the reactivity of the tetrazole functionalising agents (F) as initiators or terminators of polymers, some tests were carried out, in accordance with Schemes 7 and 8 below:

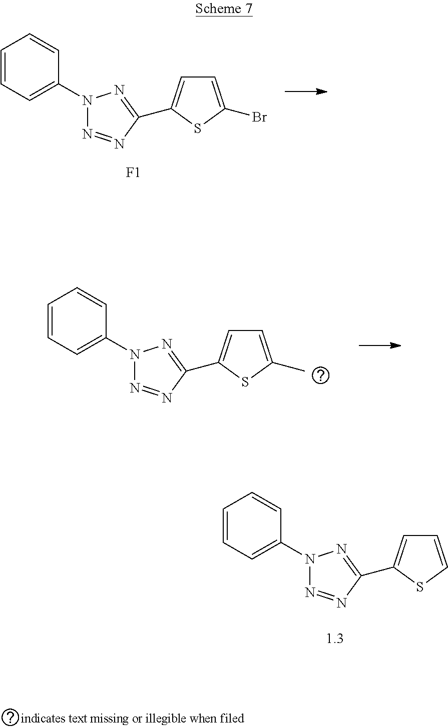

The F1 derivative was dissolved in anhydrous THF (tetrahydrofuran), under a nitrogen atmosphere, cooling with an ice bath. Subsequently, n-BuLi (butyl-lithium) was added and stirred for 1 h. The reaction was quenched by adding ethanol to the reaction environment. The NMR analysis of the crude showed the formation of the 1.3 species. From the reaction with n-BuLi reported above, the stability of the tetrazole system under the conditions of carbanion formation and the actual formation of the anion in substitution of bromine were highlighted. By quenching it with ethanol it was possible to confirm the suitability of use of the agent (F1) as anionic polymerisation initiator.

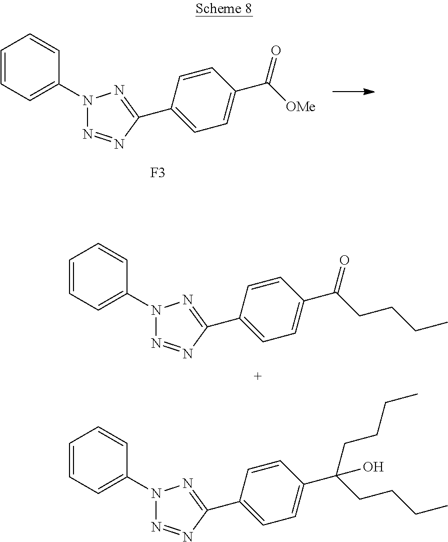

The F3 derivative was dissolved in anhydrous THF (tetrahydrofuran), under a nitrogen atmosphere, cooling with an ice bath. Subsequently, n-BuLi (butyl-lithium) was added and stirred for 1 h. NMR analysis of the crude reaction product showed the formation of a mixture of the unreacted starting product (F3) and of the two mono and dialkylation derivatives.

The above reaction highlighted the stability of the tetrazole system under the alkylation conditions, the effective reactivity of the ester group with the lithium alkyls to give derivatives in which the alkyl lithium carbanion was found bound to the functionalising agent and consequently, the suitability of use of the agent (F3) as anionic polymerization terminator.

The monoaddition product, i.e. the ketone was characterised for TGA using method 3 described above: approximately 10 mg of tetrazole were dispersed in about 10 mg of S-SBR (Ricon 100) and the mixture placed in the TGA crucible using a thermal program from 30° C. to 400° C. with a ramp of 5°/min under a N₂ flow.

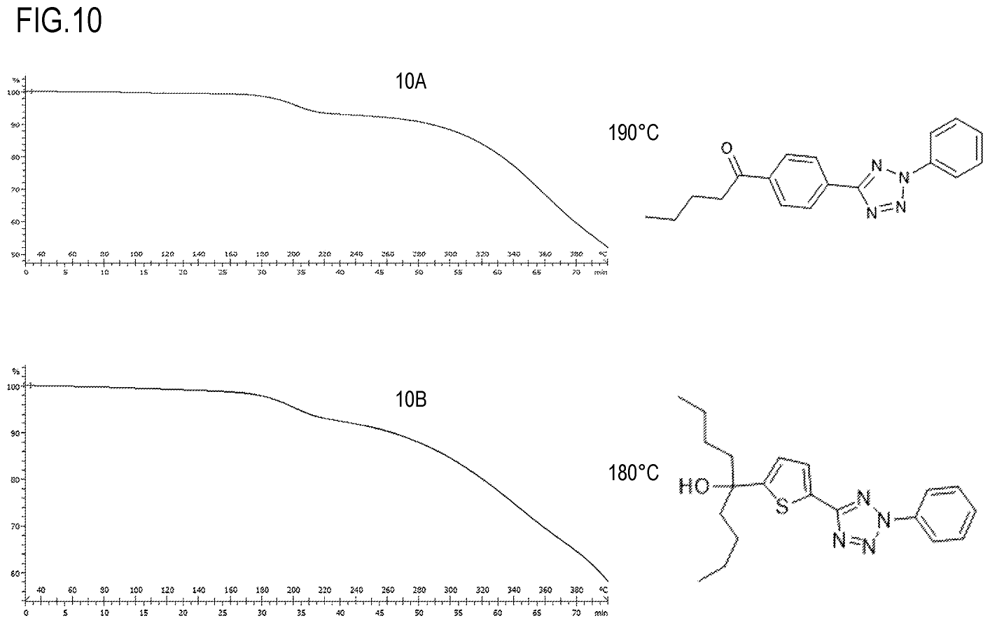

The thermogram is shown in FIG. 10: the weight loss at about 190° C. showed that derivatisation with an alkyl chain, which we may consider a model for the polymer chain, did not significantly shift the activation T of F3.

### Example 5: Preparation of Functionalised Oligomers (Post-Polymerisation Functionalisation)

To verify the feasibility of functionalisation of a diene polymer already formed and bearing suitable reactive groups such as hydroxyl, a functionalisation test was carried out starting from the Krasol® LBH 2000 oligomer (liquid polybutadienediol produced by Cray Valley, 1.2-vinyl content: 65%, density at 20° C. 0.9 g/cc, Mn 2100 g/mol) by reaction with the 2,5 disubstituted tetrazole functionalising agent (F5), according to the following Scheme 9:

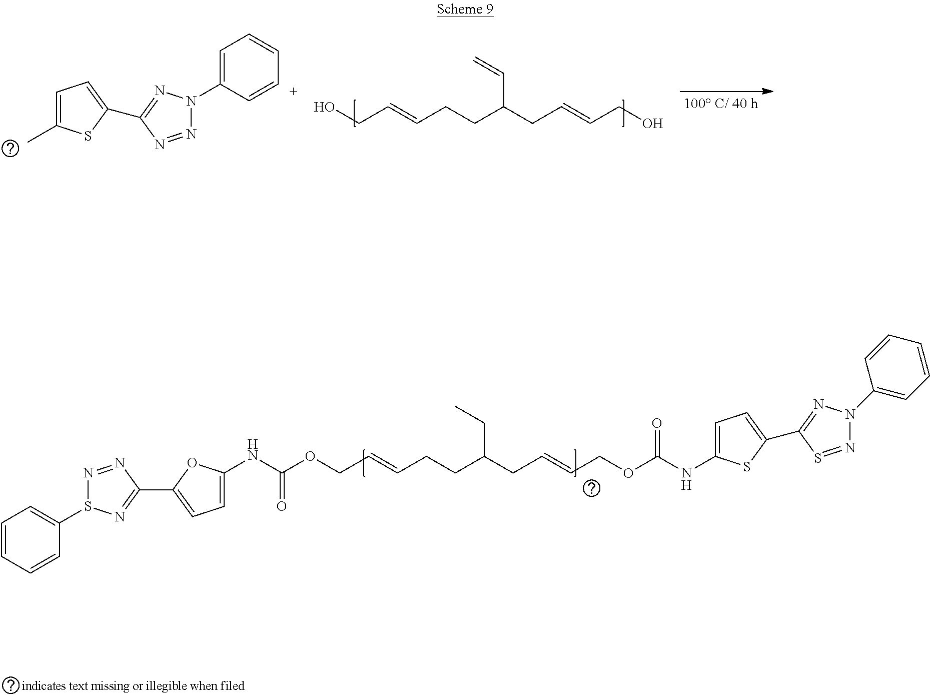

Advantageously, the terminated Krasol OH is a liquid, therefore the reaction with the functionalising agent (F5) could be carried out in the absence of solvent.

In particular, Krasol LBH 2000 (1 eq.) and F5 (2 eq.) were mixed directly in bulk. The system was heated for 40 h at 100° C. under vigorous stirring. The progress of the reaction was monitored by IR (the NCO band, isocyanate disappeared). The polymer was washed from any unreacted tetrazole by precipitating it in methanol and centrifuging (×3 times).

The product obtained was analysed by NMR, demonstrating the successful reaction by virtue of the presence of aromatic signals (in the 7-8.5 ppm region) characteristic of tetrazole and completely absent in the starting oligomer.

Furthermore, since this oligomer is rich in vinyls, a very marked fluorescence was observed when pyrazoline was formed by heating for 30 minutes at 190° C. Further evidence of the successful cross-linking reaction was the observation of the insolubility of the functionalised oligomer in dichloromethane after such heat treatment.

### Example 6

### Preparation by Anionic Polymerisation in Solution of Unmodified S-SBR (Reference S-SBR4) and of S-SBR Modified According to the Invention (S-SBR1-S-SBR3)

After loading hexane, butadiene (75 g) and styrene (25 g) into a 2 L reactor, butyl-lithium (0.01 mmol as solution in hexane) and di-tetrahydrofurfurylpropane (DPP −0.081 mmol) were added at room temperature. The reaction was then carried out for 1 h at 75° C., after which the polymerisation was terminated by adding isopropanol (2 g) and then 0.3 g of antioxidant (Irganox 1520). The S-SBR4 polymer was then dried at 75° C. under vacuum overnight.

Functionalised S-SBR polymers according to the invention (S-SBR1-S-SBR3) were prepared as described above for S-SBR4, except that at the end of the polymerisation reaction, i.e. after 1 h at 75° C., the functionalising agent (F) (0.01 mmol in THF solution) was added and the mixture was left under stirring at 75° C. for a further 15 minutes. The polymerisation was then terminated by adding isopropanol (2 g) and 0.3 g of antioxidant (Irganox 1520).

The polymerisation products were coloured. After a double washing of the products in isopropanol, to remove any excess unreacted agents (F), and drying overnight, the polymer samples were characterized by ¹H-NMR, FT-IR, GPC and thermal analysis.

The synthesis conditions and the main analytical data are summarised in the following Table 3:

TABLE 3

| | | | | Results | | | | |
|---|---|---|---|---|---|---|---|---|
| | Conditions | | | GPC | | | | |
| | | F/ | DTP/ | Mn | Mn | | | |
| Polymer | | BuLi | BuLi | main | second. | | | DSC |
| (A1)/ | | molar | molar | peak | peak | FTIR % weight | | Tg |
| ref. | F | ratio | ratio | kg/mol | kg/mol | Vinyl | Styrene | (° C.) |
| S-SBR1 | F2 | 1 | 0.84 | 193.4 | | 48.65 | 23.87 | −19.96 |
| S-SBR2 | F3 | 1 | | 177 | 366 | 48.17 | 24.28 | −20.34 |
| S-SBR3 | F4 | 1 | | 177 | 362 | 47.91 | 24.56 | −16.53 |
| S-SBR4 | — | — | | 197.7 | | 48.97 | 23.67 | −19.62 |

Key: F: functionalising agent; DTP: di-tetrahydrofurfurylpropane; second.: secondary; the weight fractions calculated by IR of Styrene and Vinyl refer to the total polymer.

### Characterisation of S-SBR1-S-SBR4 Polymers

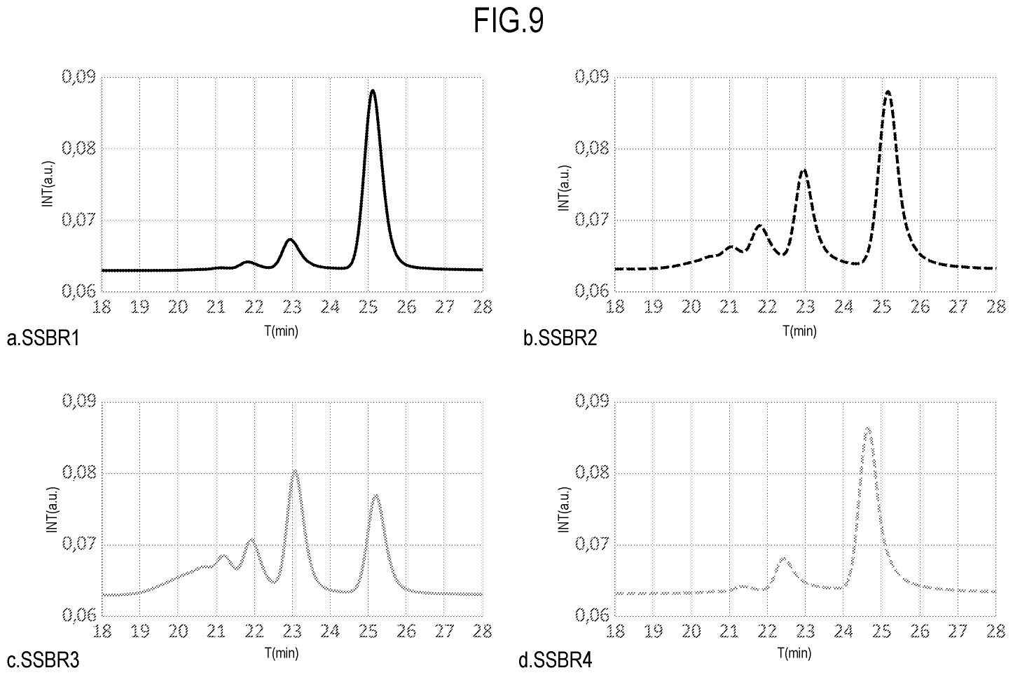

As may be seen from the GPC chromatograms of FIG. 9 (FIGS. 9A-9D) and from the data summarised in Table 3, the terminal functionalisation of the polymers with (E) groups comprising the 2,5 disubstituted tetrazoles had led, as expected, to the preservation of the molecular weight of the polymer as it is in the case of the functionalising agent F2, while in the case of the functionalising agents F3 and F4, consistently with the model reaction with BuLi reported above (Scheme 8), a substantially bimodal distribution was observed, which testifies that a fraction of the polymer chains reacted in pairs with the functionalising agent.

The GPC results showed that the main fraction of the prepared polymer was in any case characterised by a value of Mn around 180,000-200,000 g/mol.

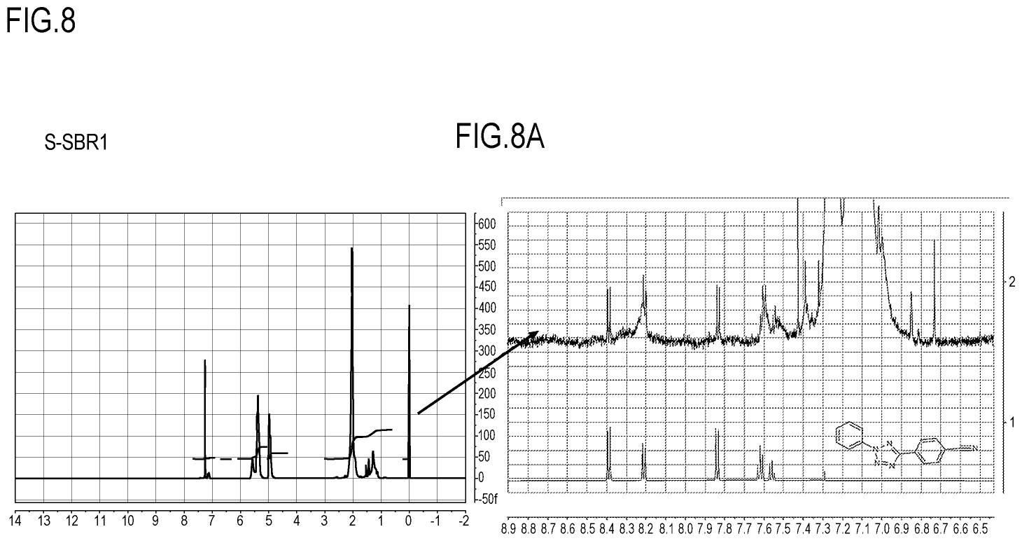

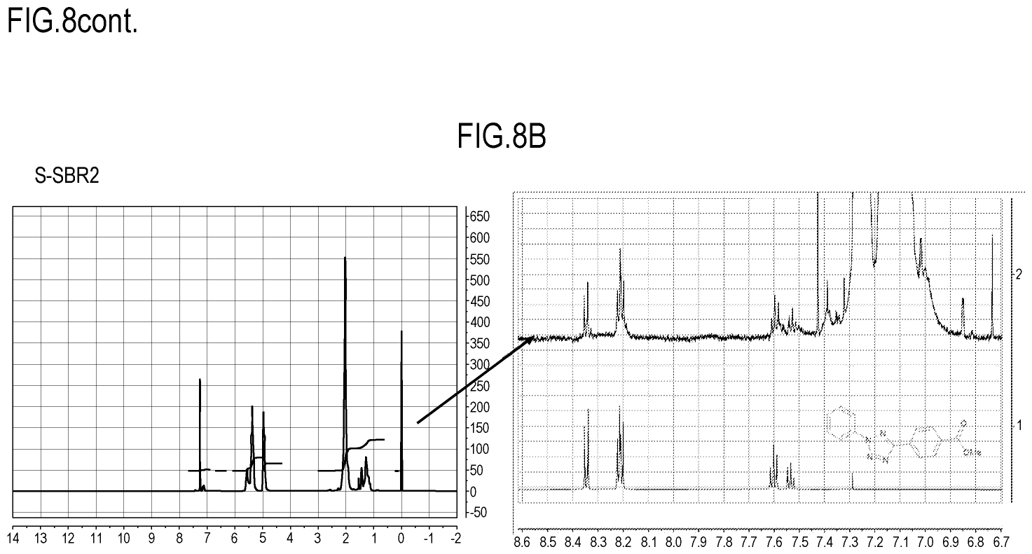

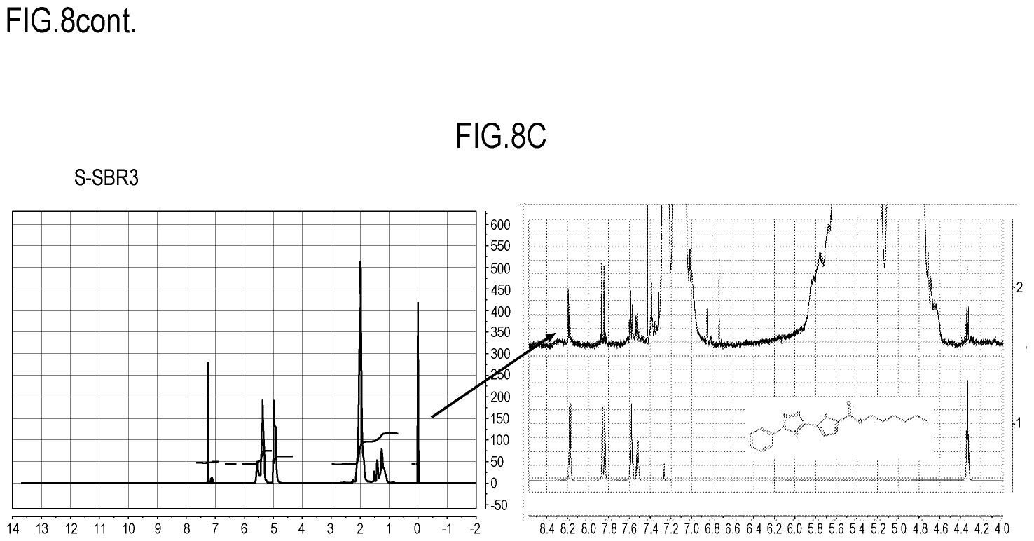

The H-NMR analysis (FIGS. 8A-8C) of the S-SBR1, S-SBR2 and S-SBR3 polymers demonstrated the presence of the functional groups (E2-E4) in the synthesised modified polymers, by reaction respectively with the functionalising agents (F2-F4).

In particular, the S-SBR polymers were characterised by the following 1H-NMR signals (400 MHz, CDCl₃): δ 7.2 (m, styrene), 4.8-5.8 (m, hydrogens bound to C═C), 1-2.3 (m, H bound to C sp3).

For the three functionalised polymers S-SBR1-S-SBR3, in the enlargement of the aromatic region, characteristic signals of the aromatic substituent groups of tetrazole were noted, which maintained a similar chemical shift after the reaction of the functional groups with the polymer carbanion.

### Heating Tests and Characterisation of S-SBR Samples

A thermal test was performed on samples of S-SBR1, S-SBR3 and S-SBR4 polymers. Considering that the groups (E) of the modified diene polymers include 2,5-disubstituted tetrazoles which decompose around 190° C. (or lower temperature) generating the nitrilimine, very reactive towards the double bonds and selective for the vinyls, samples of the modified diene polymers S-SBR1, S-SBR3 and of the reference S-SBR4 were heated at 190° C. for 20 min in a test tube and subsequently analysed by GPC. S-SBR4 showed no variations compared to the corresponding unheated sample, while in the case of S-SBR1 the polymer was less soluble in THF and, in the still soluble fraction, peaks corresponding to multiples (2×, 3×, 6×) of the molecular weight of the functionalised polymer; finally, in the case of the S-SBR3 polymer, after the heat treatment, the complete insolubility in THF was observed, which indicated a very high degree of cross-linking of the polymer. On this sample it was not possible to conduct GPC. This confirmed the presence of tetrazole groups (E) in the polymers studied.

### Example 7

Preparation of Elastomeric Compounds Reinforced with Silica

Comparative elastomeric compounds were prepared, not comprising the modified diene polymer (A1) (Example 7.1) or according to the invention (Examples 7.2 and 7.3) reinforced with silica. The quantities of the various components expressed in phr are shown in the following Table 4:

TABLE 4

| | Example | Example | Example |
|---|---|---|---|
| | 7.1 | 7.2 | 7.3 |
| Ingredients (phr) | Ref. | Inv. | Inv. |
| S-SBR4 (not functionalised) | 100 | — | — |
| S-SBR3 (functionalised with F4) | — | 100 | — |
| S-SBR2 (functionalised with F3) | — | — | 100 |
| Silica | 65 | 65 | 65 |
| 6PPD | 2.5 | 2.5 | 2.5 |
| TESPT | 4.9 | 4.9 | 4.9 |
| Stearic acid | 1.5 | 1.5 | 1.5 |
| ZnO (80%) | 3 | 3 | 3 |
| Zn soap | 2 | 2 | 2 |
| Wax | 1.5 | 1.5 | 1.5 |
| Oil | 12 | 12 | 12 |
| TMQ | 1.5 | 1.5 | 1.5 |
| TBBS | 3 | 3 | 3 |
| Sulphur (67%) | 1 | 1 | 1 |

wherein:
S-SBR4 is the non-functionalised polymer described in Example 6
S-SBR2 (F3): modified diene polymer (A1) according to the invention prepared as in Example 6;
S-SBR3 (F4): modified diene polymer (A1) according to the invention prepared as in Example 6;
Silica: ZEOSIL 1165 MP. Supplier SOLVAY RHODIA OPERATIONS
Stearic acid: Supplier TEMIX OLEO SRL
6PPD: N-(1,3-dimethylbutyl)-N′-phenyl-p-phenylenediamine, Supplier: EASTMAN ZnO (80): 80% zinc oxide, 20% polymeric binder and dispersing agent, Supplier LANXESS ADD
Zn soap is a mixture of zinc salts of fatty acids
Wax: RIOWAX BM 01 Supplier SER SpA
Oil: TDAE (Treated Distillated Aromatic Extract) process oil, Supplier Klaus Dahleke KG.
Silane: TESPT bis(triethoxysilylpropyl)tetrasulphide, Supplier Evonik Industries AG.
TBBS: N-tert-butyl-2-benzothiazolyl sulphenamide accelerant, Supplier LANXESS Chemical (China) Co., Ltd
Sulphur: Crystex OT33 amorphous sulphur, insoluble in CS2 and in toluene. Treated at 33% with hydrotreated heavy naphthenic distillate (petroleum), Supplier EASTMAN.

The mixing was carried out in several steps using an internal Brabender laboratory tangential rotor mixer (60 ml mixing chamber).

In step 1-0, 50% of the elastomer was introduced and chewed for 30 seconds at 140° C. (set temperature).

In step 1-1 the silica, the silane and the remaining elastomer were then added. The mixing was continued for 2 minutes, at 140° C.

In step 1-2, the antioxidant, the ZnO and the stearic acid were introduced. The mixing was continued for about 2 minutes, until the reaction between stearic acid and zinc was completed, again at 140° C. after which the compounds—called first step compounds—were discharged. After 12-24 hours, in step 2, carried out using the same mixer, the vulcanising agent (sulphur) and the accelerant were introduced, and the mixing continued for about 3 minutes at 90° C., when the final compounds were discharged and tested.

### Viscosity Analysis (Mooney)

Samples of the reference compound (Ex. 7.1) and of the compounds according to the invention comprising diene polymers modified with 2,5 disubstituted tetrazoles (Ex. 7.2 and 7.3) were subjected to viscosity measurement giving the results reported in the following Table 5:

TABLE 5
viscosity

| | Example | Example | Example |
|---|---|---|---|
| | 7.1 | 7.2 | 7.3 |
| | Ref. | Inv. | Inv. |
| Viscosity ML (1 + 4) | 104.70 | 93.40 | 91.20 |
| Mooney Units (UM) | | | |
| Mooney relaxation % | 89.58 | 87.96 | 91.12 |
| Mooney Relaxation Slope | −0.60 | −0.52 | −0.58 |
| (lg UM/lg s) | | | |

The Mooney viscosity and the % Mooney relaxation (measured according to ISO_289-1: 2005 Standard) are predictors of the processability which often proves critical for formulations with functionalised polymers with affinity for white fillers.

From the data reported in Table 5 it was observed that the viscosity of the compounds according to the invention was even lower than the viscosity of the reference compound comprising non-functionalised SBR. Typically, the compounds comprising conventional functionalised diene polymers, i.e. with affinity for white fillers, have higher viscosities than the corresponding reference compounds comprising non-functionalised diene polymers, giving rise to processability problems.

Also in the Mooney % relaxation the values of the compounds of the invention were comparable or even higher than the reference.

Finally, the slope values of the Mooney relaxation confirmed the good processability of the compounds of the invention.

In conclusion, all the measured viscosity data predicted for the compounds of the invention a better processability than the corresponding compounds comprising diene polymers not functionalised or functionalised with groups with affinity to conventional white fillers.

### Analysis of Rheometric and Dynamic Properties

Samples of the reference compound (Ex. 7.1) and of the compounds according to the invention comprising diene polymers modified with 2,5 disubstituted tetrazoles (Ex. 7.2 and 7.3) were subjected to measurement of the rheometric and dynamic properties providing the results reported in the following Tables 6 and 7:

TABLE 6
(RPA 170° C., 10 min)

| | Example | Example | Example |
|---|---|---|---|
| | 7.1 | 7.2 | 7.3 |
| | Ref. | Inv. | Inv. |
| ML dN m | 3.91 | 3.97 | 3.13 |
| MH dN m | 29.18 | 26.22 | 24.84 |
| TS2 min | 1.61 | 1.68 | 1.84 |
| T30 min | 3.35 | 3.46 | 3.81 |
| T60 min | 5.03 | 5.15 | 5.58 |
| T90 min | 7.86 | 7.90 | 8.20 |
| dynamic test at 70° C. | | | |
| after vulcanisation | | | |
| at 170° C. | | | |
| ΔG′ (0.4-10) (MPa) | 2.79 | 2.32 | 2.16 |
| G′ (9%) (MPa) | 2.53 | 2.22 | 2.14 |
| Tan Delta (9%) | 0.178 | 0.166 | 0.166 |

wherein
G′ (9%) was the shear elastic modulus measured at 70° C. with a deformation amplitude of 9%;
ΔG′ (0.4-10) indicated the relative difference of the dynamic modulus between 0.4% and 10% of dynamic deformation, as an index of the Payne effect:
Tan Delta (9%) represented the Tan delta value recorded at 9% of dynamic shear strain at 70° C.;

TABLE 7
(RPA 190° C., 10 min)

| | Example | Example | Example |
|---|---|---|---|
| | 7.1 | 7.2 | 7.3 |
| | Ref. | Inv. | Inv. |
| ML dN m | 3.83 | 4.12 | 2.57 |
| MH dN m | 38.16 | 34.53 | 31.37 |
| TS2 min | 0.5 | 0.48 | 0.52 |
| T90 min | 4.66 | 4.63 | 4.99 |
| dynamic test at 70° C. | | | |
| after vulcanisation | | | |
| at 170° C. | | | |
| ΔG′ (0.4-10) (MPa) | 2.48 | 2.13 | 1.59 |
| G′ (10%) (MPa) | 3.01 | 2.54 | 2.63 |
| Tan. Delta (10%) | 0.120 | 0.127 | 0.105 |

In this case, the vulcanisation in the “RPA” instrument took place at a T of 190° C. for 10 minutes. The vulcanised samples were subjected to the measurement of the dynamic shear modulus (G′) at 100° C., frequency 10 Hz, where G′ (10%) represented the elastic shear modulus measured at 100° C. with a deformation amplitude of 10%; Tan Delta (10%) represented the Tan delta value recorded at 10% dynamic shear strain at 100° C.

From the values shown in Table 6 and Table 7 it was observed that the vulcanisation kinetics of the samples were comparable both at 170 and 190° C., with substantially aligned vulcanisation curves.

On the other hand, for the compounds according to the invention, the maximum torque values MH and the values of ΔG′, indicative of the Payne effect, appeared in both cases substantially reduced compared to the reference compound, as is typical of functionalised polymers with groups having affinity for the filler: for these polymers, such a behaviour is surprising since the decrease in MH and the Payne effect is normally interpreted in terms of better polymer-filler interaction and greater dispersion of the filler itself—sought and expected for polymers functionalised with groups with affinity for the filler, but not expected precisely in the case of functionalisation with groups then capable of binding to the polymer itself. Wanting to interpret the experimental data, positive from the applicative point of view, it could be hypothesised that the pyrazoline that was generated in the cross-linking reaction also had a significant interaction with the filler, leading to a decrease in the Payne effect and MH. Particularly evident was the decrease in the Payne effect measured at 100° C. after vulcanisation at 190° C. for the compound of Example 7.3 (−36%), much higher than the corresponding decrease in the Payne effect measured after vulcanisation at 170° C. (−22%). Wanting to interpret this difference, it could be hypothesised that the compound of Example 7.3, based on the S-SBR2 polymer functionalised with F3 with activation T of 190° C., expressed itself at the highest temperatures. This hypothesis was consistent with the observation that the compound of Example 7.3 also had lower hysteresis than the reference in the case of vulcanisation at 190° C.

In conclusion, from the carried out experiments and from the results of the above tests it appeared that the modified diene polymer (A1) according to the invention had a positive effect on the dynamic properties of the compound and, in particular, led to a decrease in the hysteresis and surprisingly in the Payne effect of the vulcanised product.

### Example 8

Preparation of Elastomeric Compounds Reinforced with Carbon Black

Comparative elastomeric compounds were prepared, not including modified polymers (A1) (Example 8.1) or according to the invention (Ex. 8.2-Ex. 8.4) reinforced with carbon black. The quantities of the various components expressed in phr are shown in the following Table 8:

TABLE 8

| | Example | Example | Example | Example |
|---|---|---|---|---|
| | 8.1 | 8.2 | 8.3 | 8.4 |
| Ingredients (phr) | Ref. | Inv. | Inv. | Inv. |
| S-SBR (not functionalised) | 100 | — | — | — |
| S-SBR3 (functionalised with F4) | — | 100 | — | — |
| S-SBR2 (functionalised with F3) | — | — | 100 | — |
| S-SBR1 (functionalised with F2) | — | — | — | 100 |
| Silica | 35 | 35 | 35 | 35 |
| 6PPD | 2.5 | 2.5 | 2.5 | 2.5 |
| CB N234 Carbon black | 30 | 30 | 30 | 30 |
| TESPT | 2.63 | 2.63 | 2.63 | 2.63 |
| Stearic acid | 1.5 | 1.5 | 1.5 | 1.5 |
| ZnO (80%) | 3 | 3 | 3 | 3 |
| Zn soap | 2 | 2 | 2 | 2 |
| Wax | 1.5 | 1.5 | 1.5 | 1.5 |
| Oil | 12 | 12 | 12 | 12 |
| TMQ | 1.5 | 1.5 | 1.5 | 1.5 |
| TBBS | 3 | 3 | 3 | 3 |
| Sulphur (67%) | 1 | 1 | 1 | 1 |

S-SBR1 (F2): modified styrene-butadiene copolymer (A1) according to the invention prepared as in Example 6:

CB N234: Birla Carbon grade N234 carbon black,

while the remaining ingredients were like those described at the bottom of Table 4.

The compounds were prepared as described in Example 7.

In the mixing preparation steps, none of the process problems typical of conventional functionalised polymers characterised by groups interacting with the filler were observed.

### Analysis of Rheometric and Dynamic Shear Properties

Samples of the reference compound (Ex. 8.1) and of the compounds according to the invention comprising diene polymers modified with 2,5 disubstituted tetrazoles (Ex. 8.2, 8.3 and 8.4) were subjected to measurement of the rheometric and dynamic properties providing the results reported in the following Table 9:

TABLE 9
(RPA 170° C., 10 min)

| | Example | Example | Example | Example |
|---|---|---|---|---|
| | 8.1 | 8.2 | 8.3 | 8.4 |
| | Ref. | Inv. | Inv. | Inv. |
| ML dN m | 2.32 | 2.99 | 2.31 | 2.55 |
| MH dN m | 23.09 | 20.50 | 20.58 | 21.58 |
| TS2 min | 2.24 | 2.33 | 2.36 | 2.40 |
| T30 min | 3.72 | 3.56 | 3.68 | 3.79 |
| T60 min | 5.31 | 5.17 | 5.31 | 5.38 |
| T90 min | 7.96 | 7.95 | 8.09 | 8.07 |
| dynamic test at 70° C. | | | | |
| after vulcanisation | | | | |
| at 170° C. | | | | |
| ΔG′ (0.4-10) (MPa) | 2.73 | 2.31 | 2.64 | 2.67 |
| G′ (9%) (MPa) | 2.00 | 1.92 | 2.01 | 2.11 |
| Tan Delta (9%) | 0.203 | 0.185 | 0.203 | 0.197 |

wherein
G′ (9%) was the shear elastic modulus measured at 70° C. with a deformation amplitude of 9%;
ΔG′ (0.4-10) indicated the difference of the dynamic modulus between 0.4% and 10% of dynamic deformation, as an index of the Payne effect;
Tan Delta (9%) represented the Tan delta value recorded at 9% of dynamic shear strain at 70° C., respectively.

From the values shown in Table 9 it was observed that the vulcanisation kinetics of the samples were comparable, with substantially aligned vulcanisation curves. For the compounds according to the invention, the maximum torque values MH appeared to be reduced with respect to the reference compound. Furthermore, the compounds according to the invention showed dynamic modulus values substantially in line, values of ΔG′ lower than the reference, therefore a lower Payne effect, especially for the compound of Ex. 8.2, and reduced hysteresis, in particular again for the compound of Ex. 8.2 comprising S-SBR3 functionalised with F4, having a lower activation T (170° C.) than F2 and F3 respectively used in the preparation of S-SBR1 and S-SBR2, incorporated in the compounds of Examples 8.4 and 8.3, respectively.

The compound of Ex. 8.2 therefore showed more the typical effects of the present functionalisation in terms of unchanged vulcanisation curve and reduced hysteresis after vulcanisation. Furthermore, such compound showed surprisingly in a particularly marked way a lower MH and a decreased Payne effect, which suggested a better dispersion of the filler, a typical effect of the compounds with functionalised polymers with groups with affinity for the filler but unexpected in the present case of polymers with functionalisation designed to react with the polymer itself. As above, we could hypothesise that the pyrazoline formed by the reaction of tetrazole with the polymer also had a significant interaction with the black filler.

### Analysis of Mechanical Tensile Properties

Samples of the reference compound (Ex. 8.1) and of the compounds according to the invention comprising diene polymers modified with 2,5 disubstituted tetrazoles (Ex. 8.2, 8.3 and 8.4) were subjected to measurement of the tensile mechanical properties on specimens vulcanised at 190° C. for 10 minutes. The results are reported in the following Table 10:

TABLE 10
Dumbell tractions after vulcanisation at 190° C., 10 min

| | Example | Example | Example | Example |
|---|---|---|---|---|
| | 8.1 | 8.2 | 8.3 | 8.4 |
| | Ref. | Inv. | Inv. | Inv. |
| Ca0.1 MPa | 1.03 | 0.95 | 1.06 | 1.03 |
| Ca0.5 MPa | 2.23 | 2.05 | 2.21 | 2.22 |
| Ca1 MPa | 4.09 | 3.69 | 3.94 | 3.96 |
| Ca3 MPa | 18.44 | 17.59 | 18.00 | 19.20 |
| CR MPa | 19.78 | 20.90 | 20.60 | 20.71 |
| AR % | 318.18 | 344.82 | 341.54 | 318.32 |
| Energy J/cm³ | 27.61 | 31.24 | 31.08 | 28.01 |

From the data reported in the table, it may be seen that the compounds obtained from functionalised polymers (A1) according to the invention showed in all cases an improvement in the static properties.

In conclusion, in the light of the experimental tests reported, it was highlighted that the modified diene polymer (A1) of the invention led to a significant decrease in the Payne effect, considered of technological interest as an index of greater linearity of the mechanical response of the tyre and driving precision of the vehicle. A tyre with a linear response is more predictable, therefore, it is safer.

Furthermore, the modified diene polymer (A1) resulted in a significant reduction of the hysteresis at 70° C. of the compound. Since the hysteresis at 70° C. is considered a predictor of tyre rolling resistance, it could be concluded that the modified diene polymer (A1) of the invention had the requirements to be advantageously used in tyre components, in particular in the tread band, to give less rolling resistance and, last but not least, to limit vehicle consumption.

Finally, by appropriately selecting the substituents present on the tetrazole, their activation temperature could be modified bringing it to values similar or decidedly different from those of sulphur vulcanisation, being able to spread in terms of application opportunities.

For example, by selecting a modified diene polymer (A1) with a tetrazole having an activation temperature higher than the temperatures adopted in the initial mixing steps, it was possible to minimise the thickening phenomena typical of conventional functionalised diene polymers with high affinity for the reinforcing fillers and to trigger only subsequently the anchoring reactions.

1-16. (canceled)

17. A modified diene polymer terminated with at least one tetrazole group comprising at least one 2,5 disubstituted tetrazole, wherein the modified diene polymer has a number average molecular weight Mn higher than 50,000 g/mol, as measured by gel permeation chromatography (GPC) according to ISO 11344 standard method.

18. The polymer according to claim 17, wherein the number average molecular weight Mn is higher than 100,000 g/mol, as measured by GPC according to ISO 11344.

19. The polymer according to claim 18, wherein the number average molecular weight Mn is higher than 150,000 g/mol, as measured by GPC according to ISO 11344.

20. The polymer according to claim 17, wherein the tetrazole group is a group comprising a tetrazole covalently linked in position 2, in position 5, or in position 2 and position 5 to the polymer, of formula (E): 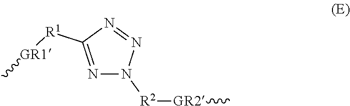
wherein the symbol [symbol] represents an optional covalent bond with the diene polymer,
R1 and R2, are the same or different from each other and different from H, represent a monovalent or divalent organic residue, provided at least one of the two is divalent, and
GR1′, GR2′, or GR1′ and GR2′, optionally present, represent the residue of a reactive group respectively GR1, GR2, or GR1 and GR2 after the reaction with the diene polymer, provided at least one covalent bond with the diene polymer is present.

21. The polymer according to claim 20, wherein the number average molecular weight Mn is higher than 150,000 g/mol, as measured by GPC according to ISO 11344.

22. The polymer according to claim 20, wherein the groups R1 and R2 are independently selected from optionally substituted C₁-C₃₀ alkyl/ylene, C₆-C₂₀ aryl/ylene, heterocyclyl/ylene, —O—C₁-C₂₀ alkoxy/alkoxylene, polyoxyethyl/polyoxyethylene, polyterpenes, and combinations thereof.

23. The polymer according to claim 20, wherein R1, R2, or R1 and R2 represent an optionally substituted residue derived from phenyl or thiophene.

24. The polymer according to claim 20, wherein GR1′, GR2′, or GR1′ and GR2′ represent —CO—, —C(OH)R3-, —Si(R4)₂-, —Si(R4)(OR4)-, —Si(OR4)₂-o-NHCO—, wherein R3 represents H or R4, and R4 independently represent linear or branched C₁-C₂₀ alkyl or alkenyl, C₆-C₂₀ aryl, C₃-C₁₀ cycloalkyl or cycloalkenyl, saturated, unsaturated or aromatic monocyclic heterocyclyl, with 5- or 6-membered rings comprising at least one heteroatom selected from N, S, O, and substituted derivatives thereof.

25. The polymer according to claim 17, wherein from 0.01% to 0.5% mol of the tetrazole group is present.

26. The polymer according to claim 17, wherein from 8% to 70% by weight of styrene monomer and from 30% to 92% by weight of diene monomer are present.

27. The polymer according to claim 17, wherein an activation temperature of the tetrazole of the tetrazole group is between 120° C. and 200° C.

28. The polymer according to claim 27, wherein the activation temperature of the tetrazole of the tetrazole group is between 140° C. to 170° C.

29. The polymer according to claim 21, wherein the activation temperature of the tetrazole of the tetrazole group is between 140° C. to 170° C.

30. A tyre compound composition comprising at least
100 phr of at least one elastomeric polymer,
wherein the 100 phr comprises at least 10 phr of at least one modified diene polymer according to claim 17,
at least 10 phr of at least one reinforcing filler, and
from 0 to 20 phr of a vulcanising agent.

31. The composition according to claim 30, wherein the 100 phr comprises at least 50 phr of the modified diene polymer.

32. The composition according to claim 31, wherein the 100 phr comprises at least 80 phr of the modified diene polymer.

33. The composition according to claim 30, wherein the 100 phr comprises at least 80 phr of the modified diene polymer with an activation temperature from 140° C. to 170° C.

34. A green or, at least partially, vulcanised tyre compound obtained by mixing and optionally vulcanising the composition according to claim 30 or claim 33.

35. A process for preparing a green or, at least partially, vulcanised tyre compound, comprising:
i) mixing, in one or more steps, the components of the composition according to claim 30, maintaining the temperature at a value T1 lower than the minimum activation temperature of the at least one 2,5 disubstituted tetrazole of the modified diene polymer, to give a compound (I) comprising the modified diene polymer having at least one 2,5 disubstituted tetrazole unreacted, and
ii) optionally heating the compound (I) to a temperature T2 at least equal to or higher than the minimum activation temperature of the at least one 2,5 disubstituted tetrazole of the modified diene polymer, to give a compound (II) wherein the at least one 2,5 disubstituted tetrazole of the modified diene polymer has reacted with the double bonds of the elastomeric polymer and/or of the diene polymer, or the elastomeric polymer and of the diene polymer.

36. A tyre component for vehicle wheels comprising, a green or, at least partially, vulcanised compound according to claim 34.

37. The tyre component according to claim 36, wherein the component is selected from among tread band, sidewall insert, and under-layer.

38. A tyre for vehicle wheels comprising at least one tyre component according to claim 36.
